(19) United States
(12) Patent Application Publication
(10) Pub. No.: US 2014/0315018 A1
(43) Pub. Date: Oct. 23, 2014

(54) PRESSURE-SENSITIVE ADHESIVE COMPOSITION, PRESSURE-SENSITIVE ADHESIVE SHEET, SURFACE PROTECTIVE SHEET, AND OPTICAL FILM

(71) Applicant: Nitto Denko Corporation, Osaka (JP)

(72) Inventors: Masato Yamagata, OSAKA (JP); Masayuki Okamoto, OSAKA (JP)

(73) Assignee: Nitto Denko Corporation, Osaka (JP)

(21) Appl. No.: 14/257,260

(22) Filed: Apr. 21, 2014

(30) Foreign Application Priority Data
Apr. 23, 2013 (JP) 2013-090268

(51) Int. Cl. C09J 7/02; G02B 1/04; C09J 133/08

(52) U.S. Cl. CPC C09J 7/0246; C09J 133/08; G02B 1/04; C09J 2201/606; C09J 2467/006; C09J 2433/00
USPC 428/354; 428/355 CN; 525/205; 525/204

(57) ABSTRACT

Provided is a pressure-sensitive adhesive composition having antistatic properties that suppresses peeling electrification voltage when peeled off from a non-antistatic adherend, low adhesive strength at high peeling speeds, adhesive strength high enough to prevent problems such as lifting and unintended separation at low peeling speeds, and an optical film to which a pressure-sensitive adhesive sheet, a surface protective sheet, and a surface protective sheet are attached, each sheet having high transparency. A pressure-sensitive adhesive composition, comprising: 100 parts by mass of a polymer (A) with a glass transition temperature of less than 0° C.; 0.1 to 20 parts by mass of a polymer (B) having a weight average molecular weight of 1,000 or more to less than 100,000 and containing a monomer unit derived from a monomer having a nitrogen-containing structure; and 0.1 to 20 parts by mass of an acidic compound (C) with a pKa of −12.0 or more to less than 3.5.

### BACKGROUND OF THE INVENTION

1. Field of the Invention

The invention relates to a pressure-sensitive adhesive composition having antistatic properties. The invention also relates to a pressure-sensitive adhesive sheet, a surface protective sheet, and an optical film, which are produced in the form of a sheet, a tape, or the like using the pressure-sensitive adhesive composition, and have antistatic properties.

The pressure-sensitive adhesive sheet produced using the antistatic pressure-sensitive adhesive composition of the invention is advantageously used for plastic products and the like which can easily generate static electricity. In particular, the pressure-sensitive adhesive sheet is useful as an antistatic pressure-sensitive adhesive sheet in static-sensitive applications such as electronic devices, and also useful as a surface protective sheet (film) for protecting the surface of optical members such as polarizing plates, wavelength plates, optical compensation films, and reflective sheets.

2. Description of the Related Art

A surface protective film, which in general has a pressure-sensitive adhesive applied on the protective film side, is bonded to an object to be protected with the adhesive interposed therebetween, and used to protect the object from scratching and staining during the working or transportation of the object. For example, a panel for a liquid crystal display includes a liquid crystal cell and optical members such as polarizing plates and wavelength plates, which are bonded to the liquid crystal cell with a pressure-sensitive adhesive. Before bonded to the liquid crystal cell, these optical members are each attached to a protective film with a pressure-sensitive adhesive interposed therebetween so that the optical members can be protected from scratching and staining.

When these optical members are each bonded to the liquid crystal cell, each protective film, which is no longer necessary, is peeled off and removed. In general, protective films and optical members are made of plastic materials and therefore are highly electrically insulating and can generate static electricity when they are rubbed or peeled off. Therefore, static electricity is generated also when a protective film is peeled off from an optical member such as a polarizing plate. If a voltage is applied to a liquid crystal in such a state that the generated static electricity still remains, the orientation of the liquid crystal molecule can be degraded, or defects can occur in the panel. To prevent such problems, surface protective films undergo various antistatic treatments.

For example, there is disclosed a method of adding at least one surfactant to a pressure-sensitive adhesive and transferring the surfactant from the adhesive to an adherend to prevent static build-up (see, for example, Patent Document 1). In this technique, however, the surfactant can easily bleed out to the surface of the pressure-sensitive adhesive, and if this technique is applied to a surface protective film, there is a risk of causing staining on the adherend. Therefore, if a low-molecular-weight-surfactant-containing pressure-sensitive adhesive is applied to an optical member-protective film, sufficient antistatic properties are difficult to achieve without degradation of the optical properties of the optical member.

There is also disclosed a method of adding, to an acrylic pressure-sensitive adhesive, an antistatic agent including polyether polyol and an alkali metal salt, so that the antistatic agent can be prevented from bleeding out to the surface of the pressure-sensitive adhesive (see, for example, Patent Document 2). In this method, however, the bleeding of the antistatic agent is inevitable, so that if the antistatic agent is actually applied to a surface protective film and then subjected to a high-temperature treatment, a bleeding phenomenon can occur to cause staining on the adherend.

There is also disclosed a technique for achieving antistatic properties and less-staining properties simultaneously, which is directed to an antistatic acrylic pressure-sensitive adhesive containing an ionic compound and an acryl-based copolymer having an alkylene oxide chain in the side chain (Patent Document 3). Unfortunately, this technique may cause a problem such as lifting or peeling.

There is also disclosed a technique for simultaneously achieving antistatic properties and prevention of lifting, peeling, and the like, which is directed to an antistatic acrylic pressure-sensitive adhesive containing an acidic compound and an acryl-based copolymer having an amide bond in the side chain (Patent Document 4). Unfortunately, in this method, the problem of a reduction in transparency may occur under high-humidity conditions.

As mentioned above, surface protective films are peeled off and removed when no longer necessary. For work efficiency, such surface protective films are often peeled off at a relatively high rate. Therefore, if surface protective films have a high adhesive strength at a high peeling speed, they can degrade work efficiency and cause the problem of damage to the protected product such as an optical member or a glass product when peeled off from the protected product. On the other hand, if surface protective films are designed to have a sufficiently low adhesive strength at a high peeling speed, problems may be caused such as lifting and unintended separation after the protected product is subjected to punching, end face polishing, or other processes. When surface protective films are used to protect the surface of optical members, the adherends are subjected to an inspection process with the surface protective films bonded thereto in some cases. Such surface protective films are required to have high transparency.

### PRIOR ART DOCUMENTS

### Patent Documents

Patent Document 1: JP-A-H09-165460

Patent Document 2: JP-A-H06-128539

Patent Document 3: JP-A-2005-206776

Patent Document 4: JP-A-2011-32418

### SUMMARY OF THE INVENTION

In view of the foregoing, it is an object of the invention to provide a pressure-sensitive adhesive composition that has antistatic properties so as to suppress peeling electrification voltage when peeled off from a non-antistatic adherend, have low adhesive strength at high peeling speeds and adhesive strength high enough to prevent problems such as lifting and unintended separation at low peeling speeds, and obtain an optical film to which a pressure-sensitive adhesive sheet, a surface protective sheet, and a surface protective sheet are attached, each sheet having high transparency.

The invention is directed to a pressure-sensitive adhesive composition, including: 100 parts by mass of a polymer (A) with a glass transition temperature of less than 0° C.; 0.1 to 20 parts by mass of a polymer (B) having a weight average molecular weight of 1,000 to less than 100,000 and containing a monomer unit derived from a monomer having a nitrogen-containing structure; and 0.1 to 20 parts by mass of an acidic compound (C) with a pKa of −12.0 to less than 3.5.

In the pressure-sensitive adhesive composition of the invention, the polymer (A) is preferably a (meth)acryl-based polymer.

In the pressure-sensitive adhesive composition of the invention, the polymer (B) is preferably a (meth)acryl-based polymer.

In the pressure-sensitive adhesive composition of the invention, the nitrogen-containing structure is preferably an amide bond and/or a nitrogen-containing heterocyclic ring.

In the pressure-sensitive adhesive composition of the invention, the acidic compound (C) is preferably a compound having a phosphate group and/or a sulfonyl group.

The invention is also directed to a pressure-sensitive adhesive layer including a product made from the pressure-sensitive adhesive composition.

The pressure-sensitive adhesive layer of the invention preferably has a gel fraction of 85.00 to 99.95% by mass.

The invention is also directed to a pressure-sensitive adhesive sheet, including: a support; and the pressure-sensitive adhesive layer formed on at least one side of the support.

In the pressure-sensitive adhesive sheet of the invention, the support is preferably an antistatically treated plastic film.

The invention is also directed to a surface protective sheet preferably including the pressure-sensitive adhesive sheet.

The invention is also directed to an optical surface protective sheet preferably including the surface protective sheet for use in protecting the surface of an optical film.

The invention is also directed to a surface protective sheet-laminated optical film, including: an optical film; and the optical surface protective sheet preferably laminated to the optical film.

### Effect of the Invention

The invention is advantageous in that it provides a pressure-sensitive adhesive composition that has antistatic properties so as to suppress peeling electrification voltage when peeled off from a non-antistatic adherend, have relatively low adhesive strength at high peeling speeds and adhesive strength high enough to prevent problems such as lifting and unintended separation at low peeling speeds, and obtain an optical film to which a pressure-sensitive adhesive sheet, a surface protective sheet, and a surface protective sheet are attached, each sheet having high transparency.

### BRIEF DESCRIPTION OF THE DRAWINGS

FIG. 1 is a side view illustrating a 180° peeling adhesive strength; and

FIG. 2 is a schematic view illustrating a peeling electrification voltage test.

### DETAILED DESCRIPTION OF THE PREFERRED EMBODIMENTS

Hereinafter, embodiments of the invention will be described in detail.

The pressure-sensitive adhesive composition of the invention contains 100 parts by mass of a polymer (A) with a glass transition temperature of less than 0°, 0.1 to 20 parts by mass of a polymer (B) having a weight average molecular weight of 1,000 to less than 100,000 and containing a monomer unit derived from a monomer having a nitrogen-containing structure, and 0.1 to 20 parts by mass of an acidic compound (C) with a pKa of −12.0 to less than 3.5.

Hereinafter, the polymer (A) and the polymer (B) will be described in detail.

### [Polymer (A)]

The polymer (A) may be of any type having a glass transition temperature of less than 0° C. The polymer (A) may be any of various polymers commonly used in pressure-sensitive adhesives, such as (meth)acryl-based polymers, rubber polymers, silicone polymers, polyurethane polymers, and polyester polymers. In particular, the polymer (A) is preferably a (meth)acryl-based polymer, which is highly transparent.

The glass transition temperature (Tg) of the polymer (A) is less than 0° C., preferably less than −10° C., more preferably less than −40° C., and generally −80° C. or more. The polymer (A) with a glass transition temperature (Tg) of 0° C. or more may be less fluid and have insufficient wettability to an adherend, which may reduce adherability.

In an embodiment, when the polymer (A) is a copolymer, its glass transition temperature is the value calculated based on formula (1) (Fox equation) below. As used herein, the term “polymer” is intended to include a homopolymer (a polymer of a single species of monomer) and a copolymer (a polymer of two or more different monomers).

1/Tg=W₁/Tg₁+W₂/Tg₂+ . . . +Wₙ/Tgₙ (1)

In formula (1), Tg is the glass transition temperature (in units of K) of a copolymer, Tgᵢ (i=1, 2, . . . , n) is the glass transition temperature (in units of K) when the monomer i formed a homopolymer, and Wᵢ (i=1, 2, . . . , n) is the weight content of the monomer i in all the monomers.

The glass transition temperature Tgᵢ for the monomer i may be a nominal value shown in references (e.g., Polymer Handbook and Pressure-Sensitive Adhesive Handbook), catalogs, or the like.

As used herein, the term “the glass transition temperature when the monomer i formed a homopolymer” means the glass transition temperature of a homopolymer of the corresponding monomer, which implies the glass transition temperature (Tg) of a polymer derived from only a single monomer (also referred to as a “monomer X”). For example, Polymer Handbook, 3rd Ed., John Wiley & Sons, Inc., 1989 shows specific values of such glass transition temperatures. The glass transition temperature (Tg) of a homopolymer not shown in the documents may be the value obtained, for example, by the following measurement method. Specifically, 100 parts by mass of a monomer X, 0.2 parts by mass of 2,2′-azobisisobutyronitrile, and 200 parts by mass of ethyl acetate as a polymerization solvent are added to a reaction vessel equipped with a thermometer, a stirrer, a nitrogen-introducing tube, and a reflux condenser. The mixture is stirred for 1 hour while nitrogen gas is introduced into the vessel. After oxygen is removed from the polymerization system in this manner, the mixture is heated to 63° C. and allowed to react for 10 hours. The reaction mixture is then cooled to room temperature to obtain a homopolymer solution with a solid concentration of 33% by mass. Subsequently, the homopolymer solution is applied by casting onto a release liner and then dried to form a test sample (homopolymer sheet) with a thickness of about 2 mm. About 1 to 2 mg of the test sample is weighed in an aluminum open cell and then subjected to temperature-modulated differential scanning calorimetry (DSC) using Q-2000 (trade name) manufactured by TA Instruments, in which the reversing heat flow (specific heat component) of the homopolymer is determined at a rate of temperature rise of 5° C./minute under a 50 ml/minute nitrogen atmosphere. According to JIS-K-7121, with respect to the resulting reversing heat flow, a straight line is drawn which is equally distant in the vertical axis direction from two straight lines obtained by extending the low temperature-side baseline and the high temperature-side baseline, and the temperature at the intersection between the drawn straight line and the curve in the region with a stepwise change of glass transition is used as the glass transition temperature (Tg) of the homopolymer.

For example, the polymer (A) preferably has a weight average molecular weight (Mw) of 30,000 to 5,000,000, more preferably 100,000 to 2,000,000, even more preferably 200,000 to 1,000,000. The polymer (A) with a weight average molecular weight (Mw) of less than 30,000 may form a pressure-sensitive adhesive (layer) with insufficient cohesive strength, which may tend cause staining on an adherend. The polymer (A) with an average molecular weight (Mw) of more than 5,000,000 may form a pressure-sensitive adhesive with lower fluidity, which may cause insufficient wettability to an adherend, thereby reducing adherability.

[(Meth)acryl-Based Polymer (a)]

A preferred example of the polymer (A) is a (meth)acryl-based polymer (hereinafter referred to as the (meth)acryl-based polymer (a)). Hereinafter, the (meth)acryl-based polymer (a) will be described in detail.

For example, the (meth)acryl-based polymer (a) is preferably a polymer including 50% by mass or more of a monomer unit derived from an alkyl (meth)acrylate having a linear or branched alkyl group of 1 to 20 carbon atoms. The (meth)acryl-based polymer (a) may be a homopolymer or copolymer of one or more alkyl (meth)acrylates having an alkyl group of 1 to 20 carbon atoms.

The (meth)acryl-based polymer (a) can be obtained using any of various polymerization methods commonly used to synthesize (meth)acryl-based polymers, such as solution polymerization, emulsion polymerization, bulk polymerization, suspension polymerization, and radiation curing polymerization. In an embodiment, when the removable pressure-sensitive adhesive sheet is used as a surface protective sheet as described below, solution polymerization or emulsion polymerization is preferably used.

The content of an alkyl (meth)acrylate having an alkyl group of 1 to 20 carbon atoms is preferably from 50 to 99.9% by mass, more preferably from 60 to 98% by mass, even more preferably from 70 to 95% by mass, based on the total weight of the monomers used to form the (meth)acryl-based polymer (a). Within these ranges, adhesive properties suitable for removable, pressure-sensitive adhesive sheets can be obtained, which is a preferred mode.

Examples of the alkyl (meth)acrylate having an alkyl group of 1 to 20 carbon atoms include C₁-C₂₀ alkyl acrylates (preferably C₂-C₁₄ alkyl acrylates, more preferably C₂-C₁₀ alkyl acrylates) such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. As used herein, the term “alkyl (meth)acrylate” refers to alkyl acrylate and/or alkyl methacrylate, and “meth” has the same meaning in all contexts.

If desired, the (meth)acryl-based polymer (a) may contain an additional component (copolymerized component) derived from any other monomer copolymerizable with the alkyl (meth)acrylate so as to modify cohesive strength, heat resistance, and crosslinkability. Therefore, the (meth)acryl-based polymer may contain a unit derived from a copolymerizable monomer together with a unit derived from the alkyl (meth)acrylate as a main component. A polar group-containing monomer is preferably used as the copolymerizable monomer. The term “main component” means a component derived from a monomer whose weight content is the highest in all the monomers.

Examples of the copolymerizable monomer include:

carboxyl group-containing monomers such as acrylic acid, methacrylic acid, carboxyethyl acrylate, carboxypentyl acrylate, itaconic acid, maleic acid, fumaric acid, crotonic acid, and isocrotonic acid;

hydroxyl group-containing monomers such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl methacrylate, and other hydroxyalkyl (meth)acrylates;

acid anhydride group-containing monomers such as maleic anhydride and itaconic anhydride;

sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid;

phosphate group-containing monomers such as 2-hydroxyethylacryloyl phosphate;

(N-substituted) amide monomers such as (meth)acrylamide, N,N-dialkyl(meth)acrylamide such as N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(tert-butyl)(meth)acrylamide, N-ethyl(meth)acrylamide, N-isopropyl(meth)acrylamide, N-butyl(meth)acrylamide, N-n-butyl(meth)acrylamide, N-methylol(meth)acrylamide, N-ethylol(meth)acrylamide, N-methylolpropane(meth)acrylamide, N-methoxymethyl(meth)acrylamide, N-methoxyethyl(meth)acrylamide, N-butoxymethyl(meth)acrylamide, and N-acryloyl morpholine;

succinimide monomers such as N-(meth)acryloyloxymethylenesuccinimide, N-(meth)acryloyl-6-oxyhexamethylenesuccinimide, and N-(meth)acryloyl-8-oxyhexamethylenesuccinimide;

maleimide monomers such as N-cyclohexylmaleimide, N-isopropylmaleimide, N-laurylmaleimide, and N-phenylmaleimide;

itaconimide monomers such as N-methylitaconimide, N-ethylitaconimide, N-butylitaconimide, N-octylitaconimide, N-2-ethylhexylitaconimde, N-cyclohexylitaconimide, and N-laurylitaconimide;

vinyl esters such as vinyl acetate and vinyl propionate;

nitrogen-containing heterocyclic monomers such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinyl morpholine, N-vinyl-2-piperidone, N-vinyl-3-morpholinone, N-vinyl-2-caprolactam, N-vinyl-1,3-oxazin-2-one, N-vinyl-3,5-morpholinedione, N-vinylpyrazole, N-vinylisoxazole, N-vinylthiazole, N-vinylisothiazole, and N-vinylpyridazine;

N-vinylcarboxylic acid amides;

lactam-containing monomers such as N-vinylcaprolactam;

cyanoacrylate monomers such as acrylonitrile and methacrylonitrile;

aminoalkyl (meth)acrylate monomers such as aminoethyl (meth)acrylate, N,N-dimethylaminoethyl (meth)acrylate, N,N-dimethylaminoethyl (meth)acrylate, and tert-butylaminoethyl (meth)acrylate;

alkoxyalkyl (meth)acrylate monomers such as methoxyethyl (meth)acrylate, ethoxyethyl (meth)acrylate, propoxyethyl (meth)acrylate, butoxyethyl (meth)acrylate, and ethoxypropyl (meth)acrylate;

styrene monomers such as styrene and α-methylstyrene;

epoxy group-containing acrylic monomers such as glycidyl (meth)acrylate;

acrylic ester monomers having a heterocyclic ring, a halogen atom, a silicon atom, or any other moiety, such as tetrahydrofurfuryl (meth)acrylate, fluorine atom-containing (meth)acrylates, and silicone (meth)acrylate;

olefin monomers such as isoprene, butadiene, and isobutylene;

vinyl ether monomers such as methyl vinyl ether and ethyl vinyl ether;

vinyl esters such as vinyl acetate and vinyl propionate;

aromatic vinyl compounds such as vinyltoluene and styrene;

olefins or dienes such as ethylene, butadiene, isoprene, and isobutylene;

vinyl ethers such as vinyl alkyl ethers;

vinyl chloride;

sulfonic acid group-containing monomers such as sodium vinylsulfonate;

imide group-containing monomers such as cyclohexylmaleimide and isopropylmaleimide;

isocyanate group-containing monomers such as 2-isocyanatoethyl (meth)acrylate;

acryloyl morpholine;

alicyclic hydrocarbon group-containing (meth)acrylates such as cyclopentyl (meth)acrylate, cyclohexyl (meth)acrylate, isobornyl (meth)acrylate, and dicyclopentanyl (meth)acrylate;

aromatic hydrocarbon group-containing (meth)acrylates such as phenyl (meth)acrylate and phenoxyethyl (meth)acrylate; and

(meth)acrylic esters derived from terpene compound-derived alcohols. These copolymerizable monomers may be used singly or in combination of two or more.

The (meth)acryl-based polymer (a) may include a unit derived from the alkyl (meth)acrylate as a main component and a unit derived from the copolymerizable monomer. In this case, a hydroxyl group-containing monomer or a carboxyl group-containing monomer is preferably used. In particular, 2-hydroxyethyl(meth)acrylate or 4-hydroxybutyl(meth)acrylate is preferably used as the hydroxyl group-containing monomer, and acrylic acid is preferably used as the carboxyl group-containing monomer.

In general, the content of the copolymerizable monomer is preferably, but not limited to, 0.1 to 40% by mass, more preferably 0.1 to 30% by mass, even more preferably 0.5 to 20% by mass, based on the total weight of all the monomers used to form the (meth)acryl-based polymer (a). When the copolymerizable monomer is added at a content of 0.01% by mass or more, a pressure-sensitive adhesive sheet having a pressure-sensitive adhesive layer made from the pressure-sensitive adhesive composition of the invention can be prevented from having a lower cohesive strength and prevented from causing staining when peeled off from an adherend. When the content of the copolymerizable monomer is 40% by mass or less, the cohesive strength can be prevented from being excessively high, and the tackiness at room temperature (25° C.) can be improved.

In the pressure-sensitive adhesive composition of an embodiment, the (meth)acryl-based polymer (a) may further contain, as monomer component, 5.0% by mass or less of a monomer unit derived from an alkylene oxide group-containing reactive monomer with an average number of moles of added oxyalkylene unit of 3 to 40.

In the alkylene oxide group-containing reactive monomer, the average number of moles of the added oxyalkylene unit is preferably from 3 to 40, more preferably from 4 to 35, even more preferably from 5 to 30, in view of its compatibility with the acidic compound (C). When the average number of added moles is 3 or more, the effect of reducing staining on an adherend (object to be protected) tends to be efficiently obtained. If the average number of added moles is more than 40, the reactive monomer can strongly interact with the acidic compound (C) so that the pressure-sensitive adhesive composition may tend to form a gel and thus to be difficult to apply, which is not preferred. The original hydroxyl group at the terminal of the oxyalkylene chain may remain or be replaced by any other functional group.

Such alkylene oxide group-containing reactive monomers may be used singly or in combination of two or more. The total content of such alkylene oxide group-containing reactive monomers in all the monomers used to form the (meth)acryl-based polymer (a) is preferably 5.0% by mass or less, more preferably 4.0% by mass or less, even more preferably 3.0% by mass or less, further more preferably 1.0% by mass or less. If the content of the alkylene oxide group-containing reactive monomer is more than 5.0% by mass, the interaction between the reactive monomer and the acidic compound (C) can be so strong as to interfere with ionic conduction and reduce antistatic properties, which is not preferred.

The oxyalkylene unit of the alkylene oxide group-containing reactive monomer may be one having an alkylene group of 1 to 6 carbon atoms, examples of which include an oxymethylene group, an oxyethylene group, an oxypropylene group, and an oxybutylene group. The hydrocarbon group of the oxyalkylene chain may be linear or branched.

The alkylene oxide group-containing reactive monomer is more preferably a reactive monomer having an ethylene oxide group. A (meth)acryl-based polymer having a unit derived from an ethylene oxide group-containing reactive monomer may be used as the base polymer (polymer (A)). In this case, the base polymer can have improved compatibility with the acidic compound (C), which makes it possible to appropriately suppress bleeding to an adherend and to obtain a less-staining pressure-sensitive adhesive composition.

The alkylene oxide group-containing reactive monomer used in an embodiment may be, for example, an alkylene oxide adduct of (meth)acrylic acid or a reactive surfactant having a reactive substituent such as an acryloyl group, a methacryloyl group, or an allyl group in the molecule.

Examples of the alkylene oxide adduct of (meth)acrylic acid include polyethylene glycol (meth)acrylate, polypropylene glycol (meth)acrylate, polyethylene glycol-polypropylene glycol (meth)acrylate, polyethylene glycol-polybutylene glycol (meth)acrylate, polypropylene glycol-polybutylene glycol (meth)acrylate, methoxypolyethylene glycol (meth)acrylate, ethoxypolyethylene glycol (meth)acrylate, butoxypolyethylene glycol (meth)acrylate, octoxypolyethylene glycol (meth)acrylate, lauroxypolyethylene glycol (meth)acrylate, stearoxypolyethylene glycol (meth)acrylate, phenoxypolyethylene glycol (meth)acrylate, methoxypolypropylene glycol (meth)acrylate, and octoxypolyethylene glycol-polypropylene glycol (meth)acrylate.

Specific examples thereof include, for example, an anion type reactive surfactant, a nonion type reactive surfactant, and a cation type reactive surfactant, having a (meth)acryloyl group, or an allyl group.

The anion type reactive surfactants, represented by the formulas (A1) to (A10), are cited as examples.

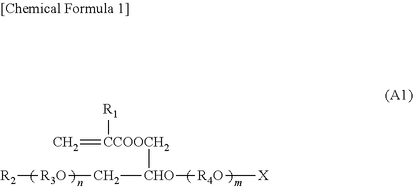

In the formula (A1), R₁ represents hydrogen or a methyl group, R₂ represents a hydrocarbon or acyl group of 1 to 30 carbon atoms, X represents an anionic hydrophilic group, R₃ and R₄ are the same or different and represent an alkylene group of 1 to 6 carbon atoms, and m and n represent an average addition mole number of 0 to 40, provided that (m+n) is a numeral of 3 to 40.

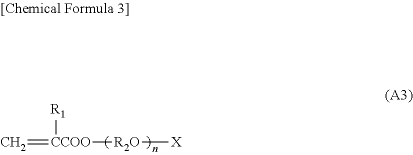

In the formula (A2), R₁ represents hydrogen or a methyl group, R₂ and R₇ are the same or different and represent an alkylene group of 1 to 6 carbon atoms, R₃ and R₅ are the same or different and represent hydrogen or an alkyl group, R₄ and R₆ are the same or different and represent hydrogen, an alkyl group, a benzyl group or a styrene group, X represents an anionic hydrophilic group, and m and n represent an average addition mole number of 0 to 40, provided that (m+n) is a numeral of 3 to 40.

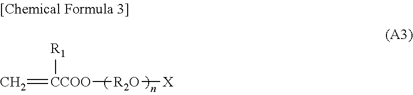

In the formula (A3), R₁ represents hydrogen or a methyl group, R₂ represents an alkylene group of 1 to 6 carbon atoms, X represents an anionic hydrophilic group, and n represents an average addition mole number of 3 to 40.

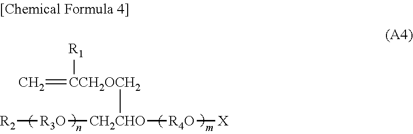

In the formula (A4), R₁ represents hydrogen or a methyl group, R₂ represents a hydrocarbon group of 1 to 30 carbon atoms or an acryl group, R₃ and R₄ are the same or different and represent an alkylene group of 1 to 6 carbon atoms, X represents an anionic hydrophilic group, m and n represent an average addition molar number of 0 to 40, provided that (m+n) is a numeral of 3 to 40.

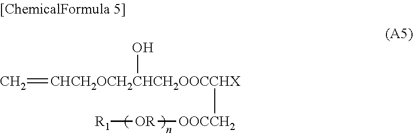

In the formula (A5), R₁ represents a hydrocarbon group, an amino group or a carboxylic acid residue, R₂ represents an alkylene group of 1 to 6 carbon atoms, X represents an anionic hydrophilic group, and n represents an average addition mole number of 3 to 40.

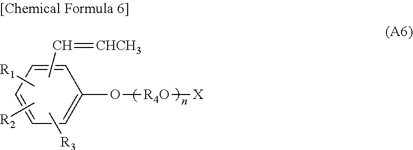

In the formula (A6), R₁ represents a hydrocarbon group of 1 to 30 carbon atoms, R₂ represents hydrogen or a hydrocarbon group of 1 to 30 carbon atoms, R₃ represents hydrogen or a propenyl group, R₄ represents an alkylene group of 1 to 6 carbon atoms, X represents an anionic hydrophilic group, and n represents an average addition mole number of 3 to 40.

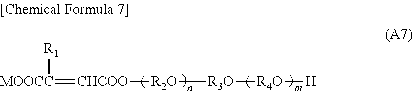

In the formula (A7), R₁ represents hydrogen or a methyl group, R₂ and R₄ are the same or different and represent an alkylene group of 1 to 6 carbon atoms, R₃ represents a hydrocarbon group of 1 to 30 carbon atoms, M represents hydrogen, an alkali metal, an ammonium group or an alkanolammonium group, and m and n represent an average addition mole number of 0 to 40, provided that (m+n) is a numeral of 3 to 40.

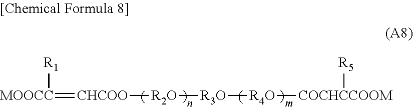

In the formula (A8), R₁ and R₅ are the same or different and represent hydrogen or a methyl group, R₂ and R₄ are the same or different and represent an alkylene group of 1 to 6 carbon atoms, R₃ represents a hydrocarbon group of 1 to 30 carbon atoms, M represents hydrogen, an alkali metal, an ammonium group or an alkanolammonium group, and m and n represent an average addition mole number of 0 to 40, provided that (m+n) is a numeral of 3 to 40.

[Chemical Formula 9]

MOOCCH═CHCOOR₁OₙR₂ (A9)

In the formula (A9), R₁ represents an alkylene group of 1 to 6 carbon atoms, R₂ represents a hydrocarbon group of 1 to 30 carbon atoms, M represents hydrogen, an alkali metal, an ammonium group or an alkanolammonium group, and n represents an average addition mole number of 3 to 40.

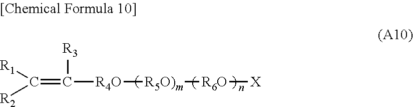

In the formula (A10), R₁, R₂ and R₃ are the same or different and represent hydrogen or a methyl group, R₄ represents a hydrocarbon group of 0 to 30 carbon atoms (which represents that R₄ is absent in case of zero carbon atom), R₅ and R₆ are the same or different and represent an alkylene group of 1 to 6 carbon atoms, X represents an anionic hydrophilic group, and m and n represent an average addition mole number of 0 to 40, provided that (m+n) is a numeral of 3 to 40.

In the formulas (A1) to (A6) and (A10), X represents an anionic hydrophilic group. Examples of the anionic hydrophilic group include those represented by the following formulas (a1) to (a2).

[Chemical Formula 11]

—SO₃M₁ (a1)

In the formula (a1), M₁ represents hydrogen, an alkali metal, an ammonium group or alkanolammonium group.

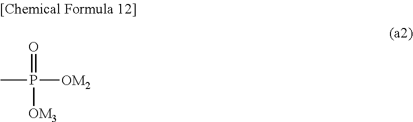

In the formula (a2), M₂ and M₃ are the same or different and represent hydrogen, an alkali group, an ammonium group or an alkanolammonium group.

Examples of the nonionic reactive surfactant include those represented by the formulas (N1) to (N6).

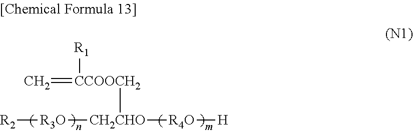

In the formula (N1), R₁ represents hydrogen or a methyl group, R₂ represents a hydrocarbon group of 1 to 30 carbon atoms or an acyl group, R₃ and R₄ are the same or different and represent an alkylene group of 1 to 6 carbon atoms, and m and n represent an average addition mole number of 0 to 40, provided that (m+n) is a numeral of 3 to 40.

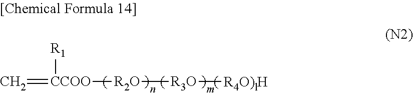

In the formula (N2), R₁ represents hydrogen or a methyl group, R₂, R₃ and R₄ are the same or different and represent an alkylene group of 1 to 6 carbon atoms, and n, m and l represent an average addition mole number of 0 to 40, provided that (n+m+l) is a numeral of 3 to 40.

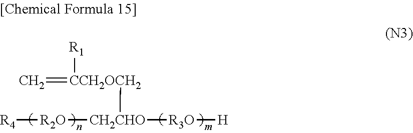

In the formula (N3), R₁ represents hydrogen or a methyl group, R₂ and R₃ are the same or different and represent an alkylene group of 1 to 6 carbon atoms, R₄ represents a hydrocarbon group of 1 to 30 carbon atoms, or an acyl group, and m and n represent an average addition mole number of 0 to 40, provided that (m+n) is a numeral of 3 to 40.

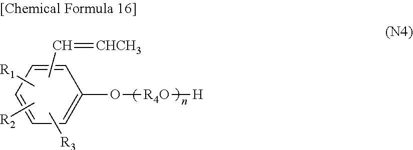

In the formula (N4), R₁ and R₂ are the same or different and represent a hydrocarbon group of 1 to 30 carbon atoms, R₃ represents hydrogen or a propenyl group, R₄ represents a alkylene group of 1 to 6 carbon atoms, and n represents an average addition mole number of 3 to 40.

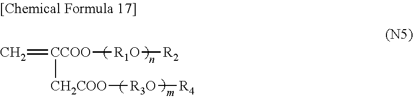

In the formula (N5), R₁ and R₃ are the same or different and represent an alkylene group of 1 to 6 carbon atoms, R₂ and R₄ are the same or different and represent hydrogen, a hydrocarbon group of 1 to 30 carbon atoms, or an acyl group, and m and n represent an average addition mole number of 0 to 40, provided that (m+n) is a numeral of 3 to 40.

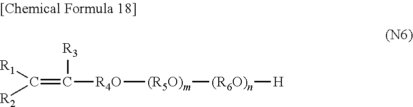

In the formula (N6), R₁, R₂ and R₃ are the same or different and represent hydrogen or a methyl group, R₄ represents a hydrocarbon group of 0 to 30 carbon atoms (which represents that R₄ is absent in case of zero carbon atom), R₅ and R₆ are the same or different and represent an alkylene group of 1 to 6 carbon atoms, and m and n represent an average addition mole number of 0 to 40, provided that (m+n) is a numeral of 3 to 40.

Examples of commercially available alkylene oxide group-containing reactive monomers include Blemmer PME-400, Blemmer PME-1000 and Blemmer 50POEP-800B (each manufactured by Nippon Oil & Fats Co., Ltd.); Latemul PD-420 and Latemul PD-430 (each manufactured by Kao Corporation); and Adekariasoap ER-10 and Adekariasoap NE-10 (each manufactured by ADEKA Corporation).

If desired, the (meth)acryl-based polymer (a) may also contain a unit derived from a polyfunctional monomer for controlling the cohesive strength of the pressure-sensitive adhesive layer to be formed.

Examples of the polyfunctional monomer include (poly) ethylene glycol di(meth)acrylate, (poly)propylene glycol di(meth)acrylate, neopentylglycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, urethane acrylate, butyl di(meth)acrylate, and hexyl di(meth)acrylate. In particular, preferably used are trimethylolpropane tri(meth)acrylate, hexanediol di(meth)acrylate, and dipentaerythritol hexa(meth)acrylate. These polyfunctional (meth)acrylates may be used singly or in combination of two or more.

The content of the polyfunctional monomer is preferably from 0.01 to 3.0% by mass, more preferably from 0.02 to 2.0% by mass, even more preferably from 0.03 to 1.0% by mass, based on the total weight of all the monomers used to form the (meth)acryl-based polymer (a), while it varies according to the molecular weight of the polyfunctional monomer, the number of the functional groups, or other conditions. If the content of the polyfunctional monomer is more than 3.0% by mass, the pressure-sensitive adhesive layer has excessively high cohesive strength, so that it may have a lower level of adhesive strength (peeling strength at a high or low peeling speed). On the other hand, if the content is less than 0.01% by mass, the pressure-sensitive adhesive layer has lower cohesive strength, so that it may cause staining when peeled off from the adherend (object to be protected).

The (meth)acryl-based polymer (a) can be easily prepared by a thermal or ultraviolet curing reaction using a polymerization initiator such as a thermal polymerization initiator or a photopolymerization initiator (photoinitiator). In particular, thermal polymerization is preferably used due to its advantage such as shorter polymerization time. A single polymerization initiator may be used, or two or more polymerization initiators may be used in combination.

Examples of the thermal polymerization initiator include azo polymerization initiators (e.g., 2,2′-azobisisobutyronitrile, 2,2′-azobis-2-methylbutyronitrile, dimethyl 2,2′-azobis(2-methylpropionate), 4,4′-azobis-4-cyanovalerianic acid, azobisisovaleronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutylamidine)dihydrochloride); peroxide polymerization initiators (e.g., dibenzoyl peroxide, tert-butyl permaleate, and lauroyl peroxide); and redox polymerization initiators, etc.

The mixing amount of the thermal polymerization initiator is typically, but not limited to, 0.01 to 5 parts by mass, more preferably 0.05 to 3 parts by mass, based on 100 parts by mass of all the monomers used to form the (meth)acryl-based polymer (a).

Examples of the photopolymerization initiator include, but are not limited to, benzoin ether photopolymerization initiators, acetophenone photopolymerization initiators, α-ketol photopolymerization initiators, aromatic sulfonyl chloride photopolymerization initiators, photoactive oxime photopolymerization initiators, benzoin photopolymerization initiators, benzil photopolymerization initiators, benzophenone photopolymerization initiators, ketal photopolymerization initiators, thioxanthone photopolymerization initiators, acylphosphine oxide photopolymerization initiators, etc.

Specifically, examples of benzoin ether photopolymerization initiators include benzoin methyl ether, benzoin ethyl ether, benzoin propyl ether, benzoin isopropyl ether, benzoin isobutyl ether, 2,2-dimethoxy-1,2-diphenylethan-1-one (IRGACURE 651 (trade name) manufactured by BASF), anisoin methyl ether, etc. Examples of acetophenone photopolymerization initiators include 1-hydroxycyclohexyl phenyl ketone (IRGACURE 184 (trade name) manufactured by BASF), 4-phenoxy dichloroacetophenone, 4-tert-butyl-dichloroacetophenone, 1-[4-(2-hydroxyethoxy)-phenyl]-2-hydroxy-2-methyl-1-propan-1-one (IRGACURE 2959 (trade name) manufactured by BASF), 2-hydroxy-2-methyl-1-phenyl-propan-1-one (DAROCUR 1173 (trade name) manufactured by BASF), methoxy acetophenone, etc. Examples of α-ketol photopolymerization initiators include 2-methyl-2-hydroxypropiophenone, 1-[4-(2-hydroxyethyl)-phenyl]-2-hydroxy-2-methylpropan-1-on e, etc. Examples of aromatic sulfonyl chloride photopolymerization initiators include 2-naphthalene sulfonyl chloride, etc. Examples of photoactive oxime photopolymerization initiators include 1-phenyl-1,1-propanedione-2-(o-ethoxycarbonyl)-oxime, etc.

Also, examples of benzoin photopolymerization initiators include benzoin, etc. Examples of benzil photopolymerization initiators include benzil, etc. Examples of benzophenone photopolymerization initiators include benzophenone, benzoylbenzoic acid, 3,3′-dimethyl-4-methoxybenzophenone, polyvinyl benzophenone, α-hydroxycyclohexyl phenyl ketone, etc. Examples of ketal photopolymerization initiators include benzyl dimethyl ketal, etc. Examples of thioxanthone photopolymerization initiators include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone, etc.

Examples of acylphosphine photopolymerization initiators include bis(2,6-dimethoxybenzoyl)phenylphosphine oxide,
bis(2,6-dimethoxybenzoyl)(2,4,4-trimethylpentyl)phosphine oxide, bis(2,6-dimethoxybenzoyl)-n-butylphosphine oxide,
bis(2,6-dimethoxybenzoyl)-(2-methylpropan-1-yl)phosphine oxide,
bis(2,6-dimethoxybenzoyl)-(1-methylpropan-1-yl)phosphine oxide, bis(2,6-dimethoxybenzoyl)-tert-butylphosphine oxide,
bis(2,6-dimethoxybenzoyl)cyclohexylphosphine oxide,
bis(2,6-dimethoxybenzoyl)octylphosphine oxide,
bis(2-methoxybenzoyl)(2-methylpropan-1-yl)phosphine oxide,
bis(2-methoxybenzoyl)(1-methylpropan-1-yl)phosphine oxide,
bis(2,6-diethoxybenzoyl)(2-methylpropan-1-yl)phosphine oxide,
bis(2,6-diethoxybenzoyl)(1-methylpropan-1-yl)phosphine oxide,
bis(2,6-dibutoxybenzoyl)(2-methylpropan-1-yl)phosphine oxide,
bis(2,4-dimethoxybenzoyl)(2-methylpropan-1-yl)phosphine oxide,
bis(2,4,6-trimethylbenzoyl)(2,4-dipentoxyphenyl)phosphine oxide, bis(2,6-dimethoxybenzoyl)benzylphosphine oxide,
bis(2,6-dimethoxybenzoyl)-2-phenylpropylphosphine oxide,
bis(2,6-dimethoxybenzoyl)-2-phenylethylphosphine oxide,
bis(2,6-dimethoxybenzoyl)benzylphosphine oxide,
bis(2,6-dimethoxybenzoyl)-2-phenylpropylphosphine oxide,
bis(2,6-dimethoxybenzoyl)-2-phenylethylphosphine oxide,
2,6-dimethoxybenzoylbenzylbutylphosphine oxide,
2,6-dimethoxybenzoylbenzyloctylphosphine oxide,
bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide,
bis(2,4,6-trimethylbenzoyl)-2,5-diethylphenylphosphine oxide,
bis(2,4,6-trimethylbenzoyl)-2,3,5,6-tetramethylphenylphosphine oxide,
bis(2,4,6-trimethylbenzoyl)-2,4-di-n-butoxyphenylphosphine oxide, 2,4,6-trimethylbenzoyldiphenylphosphine oxide,
bis(2,6-dimethoxybenzoyl)-2,4,4-trimethylpentylphosphine oxide, bis(2,4,6-trimethylbenzoyl)isobutylphosphine oxide,
2,6-dimethoxybenzoyl-2,4,6-trimethylbenzoyl-n-butylphosphine oxide, bis(2,4,6-trimethylbenzoyl)phenylphosphine oxide,
bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, etc.

For example, the mixing amount of the photopolymerization initiator is preferably, but not limited to, 0.01 to 5 parts by mass, more preferably 0.05 to 3 parts by mass, based on 100 parts by mass of all the monomers used to form the (meth)acryl-based polymer (a). If the mixing amount of the photopolymerization initiator is less than 0.01 parts by mass, the polymerization reaction may be insufficient. If the mixing amount of the photopolymerization initiator is more than 5 parts by mass, ultraviolet rays may fail to reach the interior of the pressure-sensitive adhesive layer due to the absorption of ultraviolet rays by the photopolymerization initiator. In this case, the rate of polymerization may decrease, or the resulting polymer may have a lower molecular weight. This may reduce the cohesive strength of the resulting pressure-sensitive adhesive layer, so that the pressure-sensitive adhesive layer may partially remain on a film when peeled off from the film, which may make it impossible to reuse the film. These photopolymerization initiators may be used singly or in combination of two or more.

In the embodiment, the (meth)acryl-based polymer (a) may also be prepared as a partial polymer ((meth)acryl-based polymer syrup) obtained by a process including mixing the monomers and the polymerization initiator and applying ultraviolet (UV) rays to the mixture to partially polymerize the monomers. The polymer (B) and the acidic compound (C) described below may be added to the (meth)acryl-based polymer syrup to form a pressure-sensitive adhesive composition. The resulting pressure-sensitive adhesive composition may be applied to a certain material and then irradiated with ultraviolet rays so that the polymerization can be completed.

For example, the (meth)acryl-based polymer (a) preferably has a weight average molecular weight (Mw) of 30,000 to 5,000,000, more preferably 100,000 to 2,000,000, even more preferably 200,000 to 1,000,000. If the weight average molecular weight (Mw) is excessively lower than the above range, the pressure-sensitive adhesive layer may have insufficient cohesive strength and tend to cause staining on the adherend. On the other hand, if the weight average molecular weight (Mw) is excessively higher than the above range, the pressure-sensitive adhesive may have lower fluidity, insufficient wettability to an adherend, and lower adherability.

The (meth)acryl-based polymer (a) has a glass transition temperature (Tg) of less than 0° C., preferably less than −10° C., more preferably less than −40° C., and generally −80° C. or more. If the (meth)acryl-based polymer (a) has a glass transition temperature (Tg) of more than 0° C., the polymer may be less fluid and have insufficient wettability to an adherend and lower adherability.

In an embodiment, when the (meth)acryl-based polymer (a) is a copolymer, its glass transition temperature may be the value calculated based on formula (1) (Fox equation) shown above.

### [Polymer (B)]

The polymer (B) has a weight average molecular weight of 1,000 to less than 100,000 and contains a monomer unit (monomer component) derived from a monomer having a nitrogen-containing structure. In the pressure-sensitive adhesive composition of an embodiment, the polymer (B) functions as an aid for antistatic properties and as a component for suppressing the peeling strength at high peeling speeds. The monomer having a nitrogen-containing structure is not particularly limited and may be of any type. In particular, the polymer (B) is preferably a (meth)acryl-based polymer in which a (meth)acrylic monomer with high transparency is polymerized.

The nitrogen-containing structure is preferably an amide bond and/or a nitrogen-containing heterocyclic ring. Specifically, the monomer having a nitrogen-containing structure is more preferably an amide group-containing vinyl monomer or a nitrogen-containing heterocyclic monomer. The monomer having a nitrogen-containing structure may also be any of other monomers such as N-vinylcarboxylic acid amides, lactam-containing monomers such as N-vinylcaprolactam, and aminoalkyl (meth)acrylate monomers.

Examples of the monomer having a nitrogen-containing structure include

amide group-containing vinyl monomers such as (meth)acrylamide, N-isopropyl(meth)acrylamide, N-butyl(meth)acrylamide, N,N-diethyl(meth)acrylamide, N,N-dimethyl(meth)acrylamide, N-methylol(meth)acrylamide, N-ethylol(meth)acrylamide, N-methylolpropane(meth)acrylamide, N-methoxyethyl(meth)acrylamide, N-butoxymethyl(meth)acrylamide, and N-acryloyl morpholine;

itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide;

nitrogen-containing heterocyclic monomers such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinylmorpholine, N-vinylpyrazole, N-vinylisoxazole, N-vinylthiazole, N-vinylisothiazole, and N-vinylpyridazine; and

aminoalkyl (meth)acrylate monomers such as aminoethyl (meth)acrylate, N,N-dimethylaminoethyl (meth)acrylate, N,N-diethylaminoethyl (meth)acrylate, and tert-butylaminoethyl (meth)acrylate. Since the polymer (B) used has a monomer unit derived from the monomer having such a nitrogen-containing structure, the polymer (B) can interact with the acidic compound (C) to facilitate ionic dissociation and improve ionic conduction, so that good antistatic performance can be provided.

The polymer (B) in an embodiment may be a homopolymer of the monomer having a nitrogen-containing structure or a copolymer of the monomer having a nitrogen-containing structure and a (meth)acrylic ester monomer or any other copolymerizable monomer.

The monomer having a nitrogen-containing structure preferably has an acid dissociation constant (pKa) of 8 to 50, more preferably 8 to 30. If the pKa is lower than 8, the monomer can have very high basicity and restrain the acidic compound (C), which is not preferred. If the pKa is higher than 50, the monomer can have low basicity, be less able to dissociate hydrogen ions, and provide lower antistatic performance, which is not preferred. As used herein, the term “pKa” means the acid dissociation constant in water or dimethyl sulfoxide at 25° C. For example, dimethylaminopropylacrylamide has a pKa of 10.4 (see references such as Evans Group PKa Table, Harvard University and Technical Data from Kohjin Co., Ltd.)

A (meth)acrylic ester monomer may be used to form the polymer (B). Examples of such a (meth)acrylic ester monomer include methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, and other alkyl (meth)acrylates. When a (meth)acrylic ester monomer having such an alkyl chain is used to form a monomer unit of the polymer (B) ((meth)acryl-based polymer), the peeling strength at high peeling speeds can be prevented from increasing.

Also, the (meth)acrylic ester monomer may also be a (meth)acrylic ester having an alicyclic hydrocarbon group such as a cyclohexyl group, an isobornyl group, or a dicyclopentanyl group. Examples of such an alicyclic hydrocarbon group-containing (meth)acrylic ester include cyclohexyl (meth)acrylate (having a cyclohexyl group), isobornyl (meth)acrylate (having an isobornyl group), dicyclopentanyl (meth)acrylate (having a dicyclopentanyl group), and other esters of (meth)acrylic acid and alicyclic alcohols. When the polymer (B) ((meth)acryl-based polymer) used contains a monomer unit derived from an acrylic monomer having such a relatively bulky structure, the adherability at low peeling speeds can be improved.

Further, in an embodiment, the (meth)acrylic ester monomer ((meth)acrylic monomer) having an alicyclic hydrocarbon group or the like, which may be used to form the polymer (B), preferably further has a bridged ring structure. The term “bridged ring structure” refers to a tricyclic or polycyclic, alicyclic structure. When the polymer (B) is used which has a more bulky structure such as a bridged ring structure, the pressure-sensitive adhesive composition (pressure-sensitive adhesive sheet) of the invention can further improve adherability. In particular, the use of the polymer (B) with such a more bulky structure can more significantly improve the adherability at low peeling speeds.

The alicyclic hydrocarbon group having such a bridged ring structure may be, for example, a dicyclopentanyl group represented by formula (3a) below, a dicyclopentenyl group represented by formula (3b) below, an adamantyl group represented by formula (3c) below, a tricyclopentanyl group represented by formula (3d) below, or a tricyclopentenyl group represented by formula (3e) below. UV polymerization may be used to synthesize the polymer (B) or to form the pressure-sensitive adhesive composition. Particularly in this case, among (meth)acrylic monomers having a tricyclic or polycyclic alicyclic structure containing a bridged ring structure, a (meth)acrylic monomer having a saturated structure such as a dicyclopentanyl group of formula (3a) below, an adamantyl group of formula (3c) below, or a tricyclopentanyl group of formula (3d) below is preferably used to form the polymer (B) because such a monomer is less likely to inhibit the polymerization.

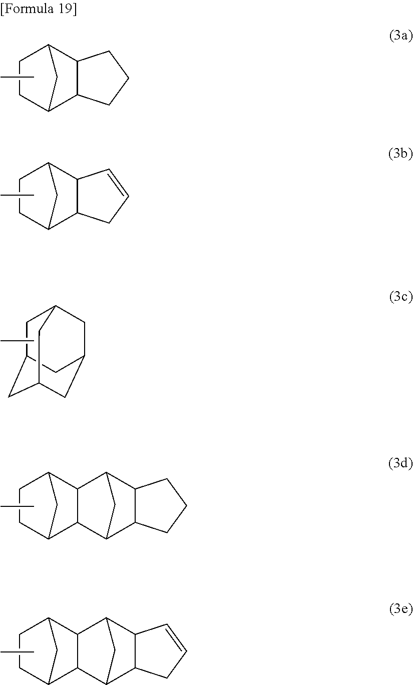

Examples of such (meth)acrylic monomers having a tricyclic or polycyclic alicyclic structure containing a bridged ring structure include dicyclopentanyl methacrylate, dicyclopentanyl acrylate, dicyclopentanyloxyethyl methacrylate, dicyclopentanyloxyethyl acrylate, tricyclopentanyl methacrylate, tricyclopentanyl acrylate, 1-adamantyl methacrylate, 1-adamantyl acrylate, 2-methyl-2-adamantyl methacrylate, 2-methyl-2-adamantyl acrylate, 2-ethyl-2-adamantyl methacrylate, 2-ethyl-2-adamantyl acrylate, and other (meth)acrylic esters. These (meth)acrylic monomers may be used singly or in combination of two or more.

The polymer (B) may include not only a monomer unit derived from the (meth)acrylic ester monomer but also any of additional units derived from other monomers polymerizable with the (meth)acrylic ester monomer (copolymerizable monomers).

Examples of such other monomers copolymerizable with the (meth)acrylic ester monomer include

aryl (meth)acrylates such as phenyl (meth)acrylate and benzyl (meth)acrylate;

(meth)acrylic esters derived from terpene compound-derived alcohols;

carboxyl group-containing monomers such as acrylic acid, methacrylic acid, carboxyethyl acrylate, carboxypentyl acrylate, itaconic acid, maleic acid, fumaric acid, crotonic acid, and isocrotonic acid;

alkoxyalkyl (meth)acrylate monomers such as methoxyethyl (meth)acrylate, ethoxyethyl (meth)acrylate, propoxyethyl (meth)acrylate, butoxyethyl (meth)acrylate, and ethoxypropyl (meth)acrylate;

salts such as alkali metal salts of (meth)acrylic acid;

(poly)alkylene glycol di(meth)acrylate monomers such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, and tripropylene glycol di(meth)acrylate;

poly(meth)acrylic ester monomers such as trimethylolpropane tri(meth)acrylate;

vinyl esters such as vinyl acetate and vinyl propionate;

halogenated vinyl compounds such as vinylidene chloride and 2-chloroethyl (meth)acrylate;

oxazoline group-containing polymerizable compounds such as 2-vinyl-2-oxazoline, 2-vinyl-5-methyl-2-oxazoline, and 2-isopropenyl-2-oxazoline;

aziridine group-containing polymerizable compounds such as (meth)acryloylaziridine and 2-aziridinylethyl (meth)acrylate;

epoxy group-containing vinyl monomers such as allyl glycidyl ether, glycidyl ether (meth)acrylate, and 2-ethylglycidyl ether (meth)acrylate;

hydroxyl group-containing vinyl monomers such as 2-hydroxyethyl (meth)acrylate, 2-hydroxypropyl (meth)acrylate, and adducts of lactones with 2-hydroxyethyl (meth)acrylate;

macro-monomers having an unsaturated group such as a (meth)acryloyl group, a styryl group, or a vinyl group bonded to the terminal of polyalkylene glycol such as polypropylene glycol, polyethylene glycol, polytetramethylene glycol, polybutylene glycol, a copolymer of polyethylene glycol and polypropylene glycol, or a copolymer of polybutylene glycol and polyethylene glycol;

fluorine-containing vinyl monomers such as fluorine-substituted alkyl (meth)acrylates;

acid anhydride group-containing monomers such as maleic anhydride and itaconic anhydride;

aromatic vinyl compound monomers such as styrene, α-methylstyrene, and vinyltoluene;

reactive halogen-containing vinyl monomers such as 2-chloroethyl vinyl ether and monochlorovinyl acetate;

succinimide monomers such as

N-(meth)acryloyloxymethylenesuccinimide, N-(meth)acryloyl-6-oxyhexamethylenesuccinimide, and N-(meth)acryloyl-8-oxyhexamethylenesuccinimide;

maleimide monomers such as N-cyclohexylmaleimide, N-isopropylmaleimide, N-laurylmaleimide, and N-phenylmaleimide;

cyanoacrylate monomers such as (meth)acrylonitrile;

imide group-containing monomers such as cyclohexylmaleimide and isopropylmaleimide;

isocyanate group-containing monomers such as 2-isocyanatoethyl (meth)acrylate;

organosilicon-containing vinyl monomers such as vinyltrimethoxysilane, γ-methacryloxypropyltrimethoxysilane, allyltrimethoxysilane, trimethoxysilylpropylallylamine, and 2-methoxyethoxytrimethoxysilane;

hydroxyl group-containing monomers such as hydroxyethyl (meth)acrylate, hydroxypropyl (meth)acrylate, hydroxybutyl (meth)acrylate, hydroxyhexyl (meth)acrylate, hydroxyoctyl (meth)acrylate, hydroxydecyl (meth)acrylate, hydroxylauryl (meth)acrylate, (4-hydroxymethylcyclohexyl)methyl methacrylate, and other hydroxyalkyl (meth)acrylates;

acrylic ester monomers having a heterocyclic ring, a halogen atom, a silicon atom, or other moieties, such as tetrahydrofurfuryl (meth)acrylate, fluorine atom-containing (meth)acrylates, and silicone (meth)acrylate;

olefin monomers such as isoprene, butadiene, and isobutylene;

vinyl ether monomers such as methyl vinyl ether and ethyl vinyl ether;

olefins or dienes such as ethylene, butadiene, isoprene, and isobutylene;

vinyl ethers such as vinyl alkyl ethers;

vinyl chloride; and

other monomers such as macro-monomers having a radically-polymerizable vinyl group attached to the terminal of a vinyl polymer. These monomers may be used singly or in any combination to be copolymerized with the (meth)acrylicester.

The polymer (B) may be, for example, a copolymer of N-vinyl-2-pyrrolidone (NVP) and 2-ethylhexyl acrylate (2EHA), a copolymer of acryloyl morpholine (ACMO) and 2-ethylhexyl acrylate (2EHA), a copolymer of acrylamide and 2-ethylhexyl acrylate (2EHA), a copolymer of N-isopropylacrylamide (NIPAM) and 2-ethylhexyl acrylate (2EHA), a copolymer of N-vinylimidazole and 2-ethylhexyl acrylate (2EHA), a copolymer of dimethylaminoethyl acrylate (DMAEA) and 2-ethylhexyl acrylate (2EHA), a copolymer of N-methylitaconimide and 2-ethylhexyl acrylate (2EHA), a copolymer of N-vinyl-2-pyrrolidone (NVP) andbutylacrylate (BA), a copolymer of acryloyl morpholine (ACMO) and butyl acrylate (BA), a copolymer of diethylacrylamide (DEAA) and butyl acrylate (BA), or a homopolymer of N-vinyl-2-pyrrolidone (NVP), acryloyl morpholine (ACMO), N-isopropylacrylamide, N-vinylimidazole, or N,N-dimethylaminoethyl acrylate.

The polymer (B) may further have an introduced functional group reactive with an epoxy group or an isocyanate group. Examples of such a functional group include a hydroxyl group, a carboxyl group, an amino group, an amide group, and a mercapto group. A monomer having such a functional group may be used (copolymerized) in the process of producing (synthesizing) the polymer (B).

The polymer (B) may be a copolymer of the monomer having a nitrogen-containing structure and the (meth)acrylic ester monomer or any other copolymerizable monomer. In this case, the content of the monomer having a nitrogen-containing structure is preferably 5% by mass or more, more preferably 10% by mass or more, even more preferably 20% by mass or more (generally less than 100% by mass, preferably 90% by mass or less) based on the total weight of all the monomers used to form the polymer (B). It is conceivable that when the monomer having a nitrogen-containing structure is added, the resulting polymer (B) can adequately interact with the acidic compound (C) to increase the ionic dissociation of the acidic compound (C), so that higher antistatic performance can be achieved. If the content is less than 5% by mass, the antistatic properties may be relatively low. When the content of the monomer having a nitrogen-containing structure is 5% by mass or more, a higher level of antistatic properties can be achieved.

The polymer (B) (especially, the (meth)acryl-based polymer) can be easily formed by a thermal or ultraviolet curing reaction using a polymerization initiator such as a thermal polymerization initiator or a photopolymerization initiator (photoinitiator), which can be used in the preparation of the (meth)acryl-based polymer (a). In particular, thermal polymerization is preferably used due to its advantage such as shorter polymerization time. A single polymerization initiator may be used, or two or more polymerization initiators may be used in combination.

Examples of the thermal polymerization initiator include azo polymerization initiators (e.g., 2,2′-azobisisobutyronitrile, 2,2′-azobis-2-methylbutyronitrile, dimethyl 2,2′-azobis(2-methylpropionate), 4,4′-azobis-4-cyanovalerianic acid, azobisisovaleronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutylamidine)dihydrochloride); peroxide polymerization initiators (e.g., dibenzoyl peroxide, tert-butyl permaleate, and lauroyl peroxide); and redox polymerization initiators, etc.

The mixing amount of the thermal polymerization initiator is typically, but not limited to, 0.01 to 5 parts by mass, more preferably 0.05 to 3 parts by mass, based on 100 parts by mass of all the monomers used to form the polymer (B).

Examples of the photopolymerization initiator include, but are not limited to, benzoin ether photopolymerization initiators, acetophenone photopolymerization initiators, α-ketol photopolymerization initiators, aromatic sulfonyl chloride photopolymerization initiators, photoactive oxime photopolymerization initiators, benzoin photopolymerization initiators, benzil photopolymerization initiators, benzophenone photopolymerization initiators, ketal photopolymerization initiators, thioxanthone photopolymerization initiators, acylphosphine oxide photopolymerization initiators, etc.

Specifically, examples of benzoin ether photopolymerization initiators include benzoin methyl ether, benzoin ethyl ether, benzoin propyl ether, benzoin isopropyl ether, benzoin isobutyl ether, 2,2-dimethoxy-1,2-diphenylethan-1-one (IRGACURE 651 (trade name) manufactured by BASF), anisoin, etc. Examples of acetophenone photopolymerization initiators include 1-hydroxycyclohexyl phenyl ketone (IRGACURE 184 (trade name) manufactured by BASF), 4-phenoxy dichloroacetophenone, 4-tert-butyl-dichloroacetophenone, 1-[4-(2-hydroxyethoxy)-phenyl]-2-hydroxy-2-methyl-1-propan-1-one (IRGACURE 2959 (trade name) manufactured by BASF), 2-hydroxy-2-methyl-1-phenyl-propan-1-one (DAROCUR 1173 (trade name) manufactured by BASF), methoxy acetophenone, etc. Examples of α-ketol photopolymerization initiators include 2-methyl-2-hydroxypropiophenone, 1-[4-(2-hydroxyethyl)-phenyl]-2-hydroxy-2-methylpropan-1-on e, etc. Examples of aromatic sulfonyl chloride photopolymerization initiators include 2-naphthalene sulfonyl chloride, etc. Examples of photoactive oxime photopolymerization initiators include 1-phenyl-1,1-propanedione-2-(o-ethoxycarbonyl)-oxime, etc.

Also, examples of benzoin photopolymerization initiators include benzoin, etc. Examples of benzil photopolymerization initiators include benzil, etc. Examples of benzophenone photopolymerization initiators include benzophenone, benzoylbenzoic acid, 3,3′-dimethyl-4-methoxybenzophenone, polyvinyl benzophenone, α-hydroxycyclohexyl phenyl ketone, etc. Examples of ketal photopolymerization initiators include benzyl dimethyl ketal, etc. Examples of thioxanthone photopolymerization initiators include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone, etc.

Examples of acylphosphine photopolymerization initiators include bis(2,6-dimethoxybenzoyl)phenylphosphine oxide,
bis(2,6-dimethoxybenzoyl)(2,4,4-trimethylpentyl)phosphine oxide, bis(2,6-dimethoxybenzoyl)-n-butylphosphine oxide,
bis(2,6-dimethoxybenzoyl)-(2-methylpropan-1-yl)phosphine oxide,
bis(2,6-dimethoxybenzoyl)-(1-methylpropan-1-yl)phosphine oxide, bis(2,6-dimethoxybenzoyl)-tert-butylphosphine oxide,
bis(2,6-dimethoxybenzoyl)cyclohexylphosphine oxide,
bis(2,6-dimethoxybenzoyl)octylphosphine oxide,
bis(2-methoxybenzoyl)(2-methylpropan-1-yl)phosphine oxide,
bis(2-methoxybenzoyl)(1-methylpropan-1-yl)phosphine oxide,
bis(2,6-diethoxybenzoyl)(2-methylpropan-1-yl)phosphine oxide,
bis(2,6-diethoxybenzoyl)(1-methylpropan-1-yl)phosphine oxide,
bis(2,6-dibutoxybenzoyl)(2-methylpropan-1-yl)phosphine oxide,
bis(2,4-dimethoxybenzoyl)(2-methylpropan-1-yl)phosphine oxide,
bis(2,4,6-trimethylbenzoyl)(2,4-dipentoxyphenyl)phosphine oxide, bis(2,6-dimethoxybenzoyl)benzylphosphine oxide,
bis(2,6-dimethoxybenzoyl)-2-phenylpropylphosphine oxide,
bis(2,6-dimethoxybenzoyl)-2-phenylethylphosphine oxide,
bis(2,6-dimethoxybenzoyl)benzylphosphine oxide,
bis(2,6-dimethoxybenzoyl)-2-phenylpropylphosphine oxide,
bis(2,6-dimethoxybenzoyl)-2-phenylethylphosphine oxide,
2,6-dimethoxybenzoylbenzylbutylphosphine oxide,
2,6-dimethoxybenzoylbenzyloctylphosphine oxide,
bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide,
bis(2,4,6-trimethylbenzoyl)-2,5-diethylphenylphosphine oxide,
bis(2,4,6-trimethylbenzoyl)-2,3,5,6-tetramethylphenylphosphine oxide,
bis(2,4,6-trimethylbenzoyl)-2,4-di-n-butoxyphenylphosphine oxide, 2,4,6-trimethylbenzoyldiphenylphosphine oxide,
bis(2,6-dimethoxybenzoyl)-2,4,4-trimethylpentylphosphine oxide, bis(2,4,6-trimethylbenzoyl)isobutylphosphine oxide,
2,6-dimethoxybenzoyl-2,4,6-trimethylbenzoyl-n-butylphosphine oxide, bis(2,4,6-trimethylbenzoyl)phenylphosphine oxide,
bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, etc.

For example, the mixing amount of the photopolymerization initiator is preferably, but not limited to, 0.01 to 5 parts by mass, more preferably 0.05 to 3 parts by mass, based on 100 parts by mass of all the monomers used to form the polymer (B). If the mixing amount of the photopolymerization initiator is less than 0.01 parts by mass, the polymerization reaction may be insufficient. If the mixing amount of the photopolymerization initiator is more than 5 parts by mass, ultraviolet rays may fail to reach the interior of the pressure-sensitive adhesive layer due to the absorption of ultraviolet rays by the photopolymerization initiator. In this case, the rate of polymerization may decrease, or the resulting polymer may have a lower molecular weight. This may reduce the cohesive strength of the resulting pressure-sensitive adhesive layer, so that the pressure-sensitive adhesive layer may partially remain on a film when peeled off from the film, which may make it impossible to reuse the film. These photopolymerization initiators may be used singly or in combination of two or more.

The polymer (B) has a weight average molecular weight of 1,000 to less than 100,000, preferably 1,500 to less than 80,000, even more preferably 2,000 to less than 60,000. A weight average molecular weight of 100,000 or more reduces the adherability at low peeling speeds. If the weight average molecular weight is less than 1,000, the polymer (B) with such a low molecular weight provides a lower level of adhesive strength (peeling strength at high or low peeling speeds) for a pressure-sensitive adhesive sheet, which is not preferred.

The weight average molecular weight of the polymers (A) and (B) can be determined as the polystyrene-equivalent molecular weight using gel permeation chromatography (GPC). Specifically, the weight average molecular weight can be determined using the method and conditions shown in the examples below.

The polymer (B) preferably has a glass transition temperature (Tg) of −70° C. to 200° C., more preferably −60° C. to 150° C., even more preferably −60° C. to 100° C., further more preferably −60° C. to 50° C. The polymer (B) with a glass transition temperature (Tg) of less than −70° C. may provide insufficient adhesive strength at low peeling speeds, and the polymer (B) with a glass transition temperature (Tg) of more than 200° C. may provide lower antistatic properties.

Table 1 shows the glass transition temperatures (Tg) of typical materials that may be used as the polymer (B) in an embodiment. The glass transition temperatures in Table 1 include nominal values shown in references (Polymer Handbook, Pressure-Sensitive Adhesive Handbook, etc.), catalogs, or other communications, and values calculated based on formula (1) (Fox equation) shown above in the case where the polymer (B) is a copolymer.

TABLE 1

| Composition of polymer | | |
|---|---|---|
| (B) | Tg (° C.) | Note |
| NVP | 54 | Reference data |
| ACMO | 145 | Reference data |
| DMAEA | 18 | Reference data |
| NIPAM | 134 | Reference data |
| NVP/2EHA = 20/80 | −53 | Calculated value |
| | | (based on Fox equation) |
| ACMO/2EHA = 60/40 | 21 | Calculated value |
| | | (based on Fox equation) |

Remarks: The abbreviations in Table 1 represent the following compounds.
NVP: N-vinyl-2-pyrrolidone
ACMO: acryloyl morpholine
DMAEA: dimethylaminoethyl acrylate
NIPAM: N-isopropylacrylamide
2EHA: 2-ethylhexyl acrylate

For example, the polymer (B) can be formed by polymerizing the monomer or monomers having the structure or structures described above using solution polymerization, emulsion polymerization, suspension polymerization, bulk polymerization, or the like.

During the polymerization, a chain transfer agent may be used to control the molecular weight of the polymer (B). Examples of chain transfer agents that may be used include mercapto group-containing compounds such as octyl mercaptan, lauryl mercaptan, tert-dodecyl mercaptan, mercaptoethanol, and α-thioglycerol; thioglycolic acid and thioglycolic esters such as methyl thioglycolate, ethyl thioglycolate, propyl thioglycolate, butyl thioglycolate, tert-butyl thioglycolate, 2-ethylhexyl thioglycolate, octyl thioglycolate, decyl thioglycolate, dodecyl thioglycolate, ethylene glycol thioglycolate, neopentyl glycol thioglycolate, and pentaerythritol thioglycolate; and α-methylstyrene dimer, etc.

In general, the mixing amount of the chain transfer agent is preferably, but not limited to, 0.1 to 20 parts by mass, more preferably 0.2 to 15 parts by mass, even more preferably 0.3 to 10 parts by mass, based on 100 parts by mass of all the monomers. When the mixing amount of the chain transfer agent is controlled in this way, the resulting polymer (B) (especially, the (meth)acryl-based polymer) can have an adequate molecular weight. These chain transfer agents may be used singly or in combination of two or more.

### [Acidic Compound (C)]

The acidic compound (C) means an Arrhenius acid. It is important for the acidic compound (C) to have a pKa of −12.0 to less than 3.5, preferably −8.0 to 3.2, and more preferably −4.0 to 3.0. If the pKa is lower than −12.0, the compound will have a very high degree of acidity, so that it can decompose the polymer added together with it and cause a reduction in the cohesive strength of the pressure-sensitive adhesive, which is not preferred. If the pKa is 3.5 or higher, the compound will have low acidity, so that dissociation of hydrogen ions will be less likely to occur and lower antistatic performance will be provided, which is not preferred.

The acidic compound (C) preferably has a phosphate group and/or a sulfonyl group. In particular, organic phosphates and organic sulfonates are preferred because they have high antistatic performance and do not decompose the pressure-sensitive adhesive. As used herein, the term “pKa” refers to an acid dissociation constant in water at 25° C., and in the case of a compound capable of undergoing multistage dissociation, such as phosphoric acid, pKa refers to pK₁ which is the value for the first-stage dissociation. For example, sulfuric acid has a pKa of −3.0, phosphoric acid has a pKa of 1.83, and acetic acid has a pKa of 4.76 (references: Kagaku Binran (Handbook of Chemistry), rev. 5th ed., the Chemical Society of Japan, pp. II-332-333 and Evans Group pKa Table, Harvard University).

It is assumed that the acidic compound (C) can interact with the nitrogen atom in the nitrogen-containing structure of the polymer (B) so that it can easily undergo ionic dissociation, which makes it possible to improve ionic conductivity and exert a peeling electrification voltage-reducing effect.

Examples of the acidic compound (C) include inorganic acids such as hydrochloric acid, sulfuric acid, nitric acid, phosphoric acid, boric acid, and carbonic acid; polyoxyethylene tridecyl ether phosphate (PLYSURF A212C and A215C manufactured by Dai-ichi Kogyo Seiyaku Co., Ltd.), polyoxyethylene alkyl (C8) ether phosphate (PLYSURF A208F manufactured by Dai-ichi Kogyo Seiyaku Co., Ltd.), polyoxyethylene alkyl (C12, C13) ether phosphate (PLYSURF A208N manufactured by Dai-ichi Kogyo Seiyaku Co., Ltd.), polyoxyethylene lauryl ether phosphate (PLYSURF A208B and A219B manufactured by Dai-ichi Kogyo Seiyaku Co., Ltd.), polyoxyethylene alkyl (C10) ether phosphate (PLYSURF A210D manufactured by Dai-ichi Kogyo Seiyaku Co., Ltd.), polyoxyethylene styrenated phenyl ether phosphate (PLYSURF AL and AL12H manufactured by Dai-ichi Kogyo Seiyaku Co., Ltd.), ethylene oxide butyl ether phosphate (PHOSPHANOL BH-650 manufactured by TOHO Chemical Industry Co., Ltd.), polyoxyethylene dodecyl ether phosphate (PHOSPHANOL ML-220, ML-240, and RD-510Y manufactured by TOHO Chemical Industry Co., Ltd.), polyoxyethylene tridecyl ether phosphate (PHOSPHANOL RS-410, RS-610, and RS-710 manufactured by TOHO Chemical Industry Co., Ltd.), polyoxyethylene octadecyl ether phosphate (PHOSPHANOL RL-210, RL-310, and RL-410 manufactured by TOHO Chemical Industry Co., Ltd.); phosphates such as hexyl phosphate, octyl phosphate, decyl phosphate, dodecyl phosphate, and tridecyl phosphate; and sulfonic acid and derivatives thereof, such as methanesulfonic acid, benzenesulfonic acid, p-toluenesulfonic acid, dodecylbenzenesulfonic acid, fluorosulfonic acid, trifluoromethanesulfonic acid, and sulfamic acid. Phosphates and sulfonic acid and derivatives thereof are particularly preferred. The acidic compound (C) may also be a polymer having a monomer unit derived from 2-sulfoethyl methacrylate or styrenesulfonic acid. These may be used singly or in combination of two or more.

### [Pressure-Sensitive Adhesive Composition]

In an embodiment, the pressure-sensitive adhesive composition contains, as essential components, the polymer (A), the polymer (B), and the acidic compound (C) described above.

The content of the polymer (B) is from 0.1 to 20 parts by mass, preferably from 0.3 to 10 parts by mass, more preferably from 0.5 to 8.0 parts by mass, based on 100 parts by mass of the polymer (A). If the polymer (B) is mixed (added) at a content of more than 20 parts by mass, the pressure-sensitive adhesive composition of an embodiment can form a pressure-sensitive adhesive layer with lower transparency, which is not preferred. If the content of the polymer (B) is less than 0.5 parts by mass, insufficient antistatic properties is provided, which is not preferred.

The content of the acidic compound (C) is from 0.1 to 20 parts by mass, preferably from 0.3 to 10 parts by mass, more preferably from 0.5 to 8.0 parts by mass, based on 100 parts by mass of the polymer (A). If the acidic compound (C) is mixed (added) at a content of more than 20 parts by mass, the pressure-sensitive adhesive composition of an embodiment can form a pressure-sensitive adhesive layer with lower cohesive strength, which tends to increase staining on adherends. If the content of the acidic compound (C) is less than 0.1 parts by mass, it is difficult to suppress the occurrence of peeling electrification voltage, which is not preferred.

The mass ratio [(B)/(C)] of the content of the polymer (B) to that of the acidic compound (C) is preferably from 0.005 to 200, more preferably from 0.01 to 100, even more preferably from 0.1 to 50, further more preferably from 0.15 to 10. When the content of the acidic compound (C) is higher than that of the polymer (B), an adequate degree of ionic dissociation can easily occur, so that good antistatic properties can be obtained, which is advantageous.

Besides the polymer (A), the polymer (B), and the acidic compound (C) described above, the pressure-sensitive adhesive composition of an embodiment may contain, as optional components, any of various additives common in the field of pressure-sensitive adhesive compositions. Examples of such optional components include tackifying resins, crosslinking agents, catalysts, plasticizers, softening agents, fillers, colorants (such as pigments and dyes), antioxidants, leveling agents, stabilizers, preservatives, antistatic agents (such as ionic liquids and alkali metal salts), etc. Such additives may be conventionally known additives and may be used in conventional ways.

The pressure-sensitive adhesive composition of an embodiment may contain a polyoxyalkylene chain-containing compound as an additive. The polyoxyalkylene chain-containing compound may be of any type having a polyoxyalkylene chain. The oxyalkylene unit may have an alkylene group of 1 to 6 carbon atoms. Examples of such an oxyalkylene unit include an oxymethylene group, an oxyethylene group, an oxypropylene group, and an oxybutylene group. The oxyalkylene chain may have a linear or branched hydrocarbon group. Examples of the polyoxyalkylene chain-containing compound include polyethylene glycol, polypropylene glycol (diol type), polypropylene glycol (triol type), polytetramethylene ether glycol, methoxypolyethylene glycol, ethoxypolyethylene glycol, and derivatives or copolymers thereof. These may be used singly or in combination of two or more. The polyoxyalkylene chain can interact with the acidic compound (C) to effectively compatibilize it with the polymer (A), so that transparency can be effectively increased.

The polyoxyalkylene chain-containing compound preferably has a number average molecular weight of 100,000 or less, more preferably 200 to 50,000. The compound with the molecular weight of more than 100,000 may increase staining on adherends.

The polyoxyalkylene chain-containing compound may be a polyoxyalkylene chain-containing organopolysiloxane represented by any one of formulae (D1), (D2), and (D3) below.

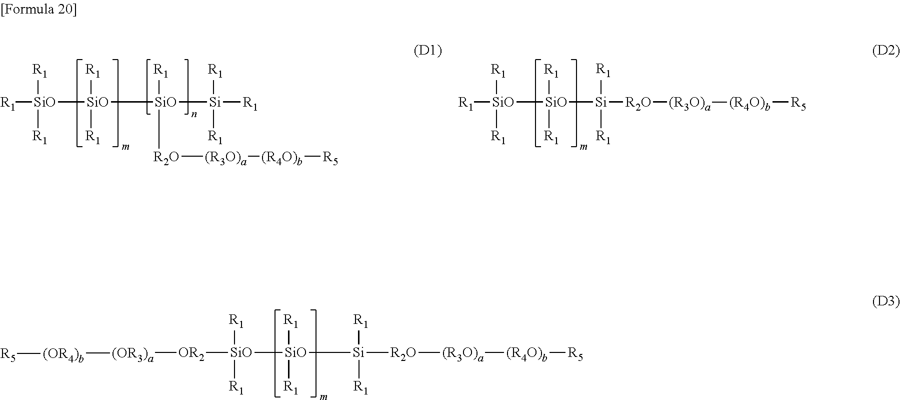

In formula (D1), R₁ is a monovalent organic group, R₂, R₃, and R₄ are each an alkylene group, R₅ is a hydrogen or an organic group, m and n are each an integer of 0 to 1,000, provided that not both m and n are 0, and a and b are each an integer of 0 to 1,000, provided that not both a and b are O.

In formula (D2), R₁ is a monovalent organic group, R₂, R₃, and R₄ are each an alkylene group, R₅ is a hydrogen or an organic group, m is an integer of 1 to 2,000, and a and b are each an integer of 0 to 1,000, provided that not both a and b are O.

In formula (D3), R₁ is a monovalent organic group, R₂, R₃, and R₄ are each an alkylene group, R₅ is a hydrogen or an organic group, m is an integer of 1 to 2,000, and a and b are each an integer of 0 to 1,000, provided that not both a and b are 0.

For example, the polyoxyalkylene chain-containing organopolysiloxane may have the structure described below. Specifically, in the formulae, the monovalent organic group represented by R₁ may be an alkyl group such as a methyl group, an ethyl group, or a propyl group, an aryl group such as a phenyl group or a tolyl group, a benzyl group, a phenethyl group, or any other alkyl group. These alkyl groups may each have a substituent such as a hydroxyl group. R₂, R₃, and R₄ may each be an alkylene group of 1 to 8 carbon atoms, such as a methylene group, an ethylene group, or a propylene group. Specifically, R₃ and R₄ are different alkylene groups, and R₂ may be the same as or different from R₃ or R₄. Any one of R₃ and R₄ is preferably an ethylene or propylene group so that an ionic compound can be dissolved at a high concentration in the polyoxyalkylene side chain. The monovalent organic group represented by R₅ may be an alkyl group such as a methyl group, an ethyl group, or a propyl group or an acyl group such as an acetyl group or a propionyl group. These groups may each have a substituent such as a hydroxyl group. These compounds may be used singly or in combination of two or more. The molecule may also have a reactive substituent such as a (meth)acryloyl group, an allyl group, or a hydroxyl group.

Examples of the polyoxyalkylene chain-containing organopolysiloxane include commercially available products such as KF-351A, KF-353, KF-945, KF-6011, KF-889, and KF-6004 (all trade names, manufactured by Shin-Etsu Chemical Co., Ltd.), FZ-2122, FZ-2164, FZ-7001, SH8400, SH8700, SF8410, and SF8422 (all trade names, manufactured by Dow Corning Toray Co., Ltd.), TSF-4440, TSF-4445, TSF-4452, and TSF-4460 (all trade names, manufactured by Momentive Performance Materials Inc.), and BYK-333, BYK-377, BYK-UV3500, and BYK-UV3570 (all trade names, manufactured by BYK Japan KK). These compounds may be used singly or in combination of two or more.

Besides the polyfunctional monomer that may be used to form the (meth)acryl-based polymer (a), a crosslinking agent may also be used to control the cohesive strength of the pressure-sensitive adhesive layer described below. Any crosslinking agent commonly used in pressure-sensitive adhesive compositions may be used, such as an epoxy crosslinking agent, an isocyanate crosslinking agent, a silicone crosslinking agent, an oxazoline crosslinking agent, an aziridine crosslinking agent, a silane crosslinking agent, an alkyl-etherified melamine crosslinking agent, or a metal chelate crosslinking agent. In particular, an isocyanate crosslinking agent, an epoxy crosslinking agent, or a metal chelate crosslinking agent is preferably used. These compounds may be used singly or in combination of two or more.

Examples of the isocyanate crosslinking agent include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylene polyphenyl isocyanate, and adducts of any of these compounds with a polyol such as trimethylolpropane. Alternatively, a compound having at least one isocyanate group and at least one unsaturated bond per molecule, such as 2-isocyanatoethyl (meth)acrylate, may also be used as an isocyanate crosslinking agent. These compounds may be used singly or in combination of two or more.

Examples of the epoxy crosslinking agent include bisphenol A, epichlorohydrin-type epoxy resins, ethylene diglycidyl ether, polyethylene glycol diglycidyl ether, glycerol diglycidyl ether, glycerol triglycidyl ether, 1,6-hexanediol diglycidyl ether, trimethylolpropane triglycidyl ether, diglycidylaniline, diamineglycidylamine, N,N,N′,N′-tetraglycidyl-m-xylylenediamine, 1,3-bis(N,N′-diamineglycidylaminomethyl)cyclohexane, etc. These compounds may be used singly or in combination of two or more.

The metal chelate crosslinking agent may include a metal component such as aluminum, iron, tin, titanium, or nickel, and a chelate component such as acetylene, methyl acetoacetate, or ethyl lactate. These compounds may be used singly or in combination of two or more.

The content of the crosslinking agent used in an embodiment is preferably from 0.01 to 15 parts by mass, more preferably from 0.5 to 10 parts by mass, based on 100 parts by mass of the polymer (A). If the content of the crosslinking agent is less than 0.01 parts by mass, the pressure-sensitive adhesive (layer) may have lower cohesive strength, so that it may cause staining on an adherend. On the other hand, if the content of the crosslinking agent is more than 15 parts by mass, the polymer may have higher cohesive strength, lower fluidity, and insufficient wettability, and thus have lower adherability.

The pressure-sensitive adhesive composition disclosed herein may further contain a crosslinking catalyst for more effectively accelerating any of the crosslinking reactions mentioned above. For example, a tin-based catalyst (especially, dibutyltin dilaurate or dioctyltin dilaurate) is preferably used as the crosslinking catalyst.

The content of the crosslinking catalyst (e.g., a tin-based catalyst such as dioctyltin dilaurate) is typically, but not limited to, 0.0001 to 1 part by weight based on 100 parts by mass of the polymer (A).

The pressure-sensitive adhesive composition disclosed herein may also contain a compound capable of undergoing keto-enol tautomerism. In a preferred mode, for example, the compound capable of undergoing keto-enol tautomerism is preferably added to the pressure-sensitive adhesive composition containing the crosslinking agent or to the pressure-sensitive adhesive composition to be used together with the crosslinking agent. This makes it possible to suppress gelation of the pressure-sensitive adhesive composition or an excessive increase in the viscosity of the pressure-sensitive adhesive composition after the addition of the crosslinking agent and to effectively extend the pot life of the pressure-sensitive adhesive composition. When at least an isocyanate compound is used as the crosslinking agent, it is particularly advantageous to add the compound capable of undergoing keto-enol tautomerism. This technique may be preferably used, for example, when the pressure-sensitive adhesive composition is in the form of an organic solvent solution or a solvent-less composition.

Any of various β-dicarbonyl compounds may be used as the compound capable of undergoing keto-enol tautomerism. Examples include β-diketones such as acetyl acetone, 2,4-hexanedione, 3,5-heptanedione, 2-methylhexan-3,5-dione, 6-methylheptan-2,4-dione, and 2,6-dimethylheptan-3,5-dione; acetoacetic esters such as methyl acetoacetate, ethyl acetoacetate, isopropyl acetoacetate, and tert-butyl acetoacetate; propionyl acetate esters such as ethyl propionyl acetate, propionyl ethyl acetate, isopropyl propionyl acetate, and tert-butyl propionyl acetate; isobutyryl acetate esters such as ethyl isobutyryl acetate, ethyl isobutyryl acetate, isopropyl isobutyryl acetate, and tert-butyl isobutyryl acetate; and malonic esters such as methyl malonate and ethyl malonate. Particularly preferred compounds include acetyl acetone and acetoacetic esters. These compounds capable of undergoing keto-enol tautomerism may be used singly or in combination of two or more.

The content of the compound capable of undergoing keto-enol tautomerism may be, for example, from 0.1 to 20 parts by mass, generally from 0.5 to 15 parts by mass (typically from 1 to 10 parts by mass) based on 100 parts by mass of the polymer (A). If the content of the compound is excessively low, the effect of use may be not good enough. On the other hand, if the compound is used in an unnecessarily large amount, it may remain in the pressure-sensitive adhesive layer to reduce the cohesive strength.

### [Pressure-Sensitive Adhesive Layer and Pressure-Sensitive Adhesive Sheet]

Next, a description will be given of a pressure-sensitive adhesive sheet having a pressure-sensitive adhesive layer made from the pressure-sensitive adhesive composition composed as described above.

The pressure-sensitive adhesive layer of an embodiment may be a layer produced by curing the pressure-sensitive adhesive composition. In other words, the pressure-sensitive adhesive layer can be formed by a process including placing (or applying or coating) the pressure-sensitive adhesive composition (or a solution of the pressure-sensitive adhesive composition) onto a suitable support and then appropriately subjecting the composition to a curing treatment. When the support is an antistatically treated plastic substrate, the pressure-sensitive adhesive layer may formed on the antistatic layer or on the non-antistatic surface. When two or more curing treatments (e.g., drying, crosslinking, and polymerization) are performed, they may be performed simultaneously or in a stepwise manner. When a partially polymerized product (polymer syrup) is used to form the pressure-sensitive adhesive composition, a copolymerization reaction is typically performed as the final curing treatment (so that the partially polymerized product is further subjected to the copolymerization reaction to form a completely polymerized product). For example, when the pressure-sensitive adhesive composition is photo-curable, photoirradiation is performed. If desired, other curing treatments such as crosslinking and drying may also be performed. For example, when it is necessary to dry the photo-curable pressure-sensitive adhesive composition, photoirradiation may be performed after drying. When a completely polymerized product is used to form the pressure-sensitive adhesive composition, drying (drying by heating), crosslinking, or other curing treatments are typically performed as needed.

The pressure-sensitive adhesive composition may be applied or coated, for example, using a conventional coater such as a gravure roll coater, a reverse roll coater, a kiss roll coater, a dip roll coater, a bar coater, a knife coater, or a spray coater. The pressure-sensitive adhesive composition may be applied directly to a support (substrate) so that a pressure-sensitive adhesive layer can be formed on it, or a pressure-sensitive adhesive layer may be formed on a release liner and then transferred onto a support (substrate).

In an embodiment, the pressure-sensitive adhesive layer preferably has a gel fraction (solvent-insoluble component content) of 85.00% by mass to 99.95% by mass, more preferably 90.00% by mass to 99.95% by mass. The pressure-sensitive adhesive layer with a gel fraction of less than 85.00% by mass may have insufficient cohesive strength so that it may cause staining when peeled off from the adherend (object to be protected). The pressure-sensitive adhesive layer with a gel fraction of more than 99.95% by mass may have excessively high a cohesive strength, so that a sufficient level of adhesive strength (peeling strength at high or low peeling speeds) may fail to be obtained. The gel fraction can be evaluated using the method described below.

For example, the thickness of the pressure-sensitive adhesive layer is generally, but not limited to, 3 to 60 μm, preferably 5 to 40 μm, more preferably 10 to 30 μm, so that good adherability can be achieved. The pressure-sensitive adhesive layer with a thickness of less than 3 μm may have insufficient adherability, so that it may cause lifting or peeling. On the other hand, the pressure-sensitive adhesive layer with a thickness of more than 60 μm may have an increased peeling strength at high peeling speeds to reduce peeling workability.

A pressure-sensitive adhesive sheet according to an embodiment includes a pressure-sensitive adhesive layer made from the pressure-sensitive adhesive composition. The pressure-sensitive adhesive sheet may include a support and the pressure-sensitive adhesive layer provided on at least one side of the support in a fixed manner, in other words, with no intention to separate the pressure-sensitive adhesive layer from the support. As used herein, the term “pressure-sensitive adhesive sheet” also encompasses products called pressure-sensitive adhesive tapes, pressure-sensitive adhesive films, pressure-sensitive adhesive labels, etc. The pressure-sensitive adhesive sheet may be shaped as desired by cutting, punching, or other processes, depending on the intended use. The pressure-sensitive adhesive layer may be not only in a continuous form but also formed in a regular pattern such as dots or stripes or in a random pattern.

Examples of the support include

plastic films such as films of polyolefins such as polyethylene, polypropylene, poly-1-butene, poly-4-methyl-1-pentene, ethylene-propylene copolymers, ethylene-1-butene copolymers, ethylene-vinyl acetate copolymers, ethylene-ethyl acrylate copolymers, and ethylene-vinyl alcohol copolymers, films of polyesters such as polyethylene terephthalate, polyethylene naphthalate, and polybutylene terephthalate, polyacrylate films, polystyrene films, films of polyamides such as nylon 6, nylon 6,6, and partially aromatic polyamide, polyvinyl chloride films, polyvinylidene chloride films, and polycarbonate films;

foam substrates such as polyurethane foams and polyethylene foams;

paper sheets such as kraft paper sheets, crepe paper sheets, and Japanese paper sheets;

fabrics such as cotton fabrics and staple fiber fabrics;

nonwoven fabrics such as polyester nonwoven fabrics and vinylon nonwoven fabrics; and

metal foils such as aluminum foils and copper foils, which may be appropriately selected and used depending on the intended use of the pressure-sensitive adhesive tape. When a removal pressure-sensitive adhesive sheet of an embodiment is used as a surface protective sheet as described below, a plastic film such as a polyolefin film, a polyester film, or a polyvinyl chloride film is preferably used as the support. Particularly when the pressure-sensitive adhesive sheet is used as an optical surface protective sheet, a polyolefin film, a polyethylene terephthalate film, a polybutylene terephthalate film, or a polyethylene naphthalate film is preferably used. Any of a non-stretched film and a stretched (uniaxially or biaxially stretched) film may be used as the plastic film.

If desired, the support may be subjected to a release treatment and an anti-pollution treatment with a silicone, fluoride, long-chain alkyl, or fatty acid amide release agent, a silica powder or the like, an adhesion facilitating treatment such as an acid treatment, an alkali treatment, a primer treatment, a corona treatment, a plasma treatment, or an ultraviolet treatment, or an antistatic treatment of coating type, kneading and mixing type, vapor-deposition type, or the like.

The thickness of the support may be appropriately selected depending on the purpose. Generally, the thickness of the support is from about 5 to about 200 μm (typically from 10 to 100 μm).

In a more preferred mode, an antistatically treated plastic film is used as the support to form a pressure-sensitive adhesive sheet of an embodiment. The antistatic treatment can prevent static build-up, which is useful in optics- or electronics-related technical fields where static build-up is a particularly serious problem. The antistatic treatment may be performed on a plastic film using, as a non-limiting example, a method of providing an antistatic layer on at least one side of a general-use film or a method of kneading a kneading-type antistatic agent into a plastic film. Examples of the method of providing an antistatic layer on at least one side of a film include a method of applying an antistatic resin composed of an antistatic agent and a resin component or applying a conductive polymer or a conductive materials-containing conductive resin; and a method of depositing a conductive materials by vapor deposition or plating.

Examples of an antistatic agent contained in an antistatic resin include a cation-type antistatic agent having a cationic functional group such as a quaternary ammonium salt, a pyridinium salt, and a primary, secondary or tertiary amino group, an anion-type antistatic agent having an anionic functional group such as a sulfonic acid salt, a sulfuric acid ester salt, a phosphonic acid salt, and a phosphoric ester salt, an amphoteric-type antistatic agent such as alkylbetain and a derivative thereof, imidazoline and a derivative thereof, and alanine and a derivative thereof, a nonion-type antistatic agent such as glycerin and a derivative thereof, and polyethylene glycol and a derivative thereof, and an ionic electrically conductive polymer obtained by polymerizing or copolymerizing a monomer having the aforementioned cation-type, anion-type, or amphoteric-type ionic electrically conductive group. These compounds may be used alone, or two or more of them may be used by mixing.

Specifically, examples of the cation-type antistatic agent include a (meth)acrylate copolymer having a quaternary ammonium group such as an alkyl trimethylammonium salt, acyloylamidopropyltrimethylammonium methosulfate, an alkylbenzylmethylammonium salt, acyl choline chloride, and polydimethylaminoethyl methacrylate, a styrene copolymer having a quaternary ammonium group such as polyvinylbenzyltrimethylammonium chloride, and a diallylamine copolymer having a quaternary ammonium group such as polydiallyldimethylammonium chloride. The compounds may be used alone, or two or more kinds may be used by mixing.

Examples of the anion-type antistatic agent include an alkyl sulfonic acid salt, an alkylbenzenesulfonic acid salt, an alkyl sulfate ester salt, an alkyl ethoxy sulfate ester salt, an alkyl phosphate ester salt, and a sulfonic acid group-containing styrene copolymer. These compounds may be used alone, or two or more kinds may be used by mixing.

Examples of the amphoteric-type antistatic agent include alkylbetain, alkylimidazoliumbetain, and carbobetaingrafted copolymer. These compounds may be used alone, or two or more kinds may be used by mixing.

Examples of the nonion-type antistatic agent include fatty acid alkylolamide, di(2-hydroxyethyl)alkylamine, polyoxyethylenealkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylenediamine, a copolymer consisting of polyether, polyester and polyamide, and methoxypolyethyleneglycol (meth)acrylate. These compounds may be used alone, or two or more kinds may be used by mixing.

Examples of the electrically conductive polymer include polyaniline, polypyrrole and polythiophene. These electrically conductive polymers may be used alone, or two or more kinds may be used by mixing.

Examples of the electrically conductive substance include tin oxide, antimony oxide, indium oxide, cadmium oxide, titanium oxide, zinc oxide, indium, tin, antimony, gold, silver, copper, aluminum, nickel, chromium, titanium, iron, covert, copper iodide, and an alloy and a mixture thereof. These electrically conductive substances may be used alone, or two or more kinds may be used by mixing.

As a resin component used in the antistatic resin and the electrically conductive resin, a generally used resin such as polyester, acryl, polyvinyl, urethane, melanine and epoxy is used. In the case of a polymer-type antistatic agent, it is not necessary that a resin component is contained. In addition, the antistatic resin component may contain compounds of a methylolated or alkylolated melanine series, a urea series, a glyoxal series, and an acrylamide series, an epoxy compound, or an isocyanate compound as a crosslinking agent.

An antistatic layer is formed, for example, by diluting the aforementioned antistatic resin, electrically conductive polymer or electrically conductive resin with a solvent such as an organic solvent and water, and coating this coating solution on a plastic film, followed by drying.

Examples of an organic solvent used in formation of the antistatic layer include methyl ethyl ketone, acetone, ethyl acetate, tetrahydrofuran, dioxane, cyclohexanone, n-hexane, toluene, xylene, methanol, ethanol, n-propanol and isopropanol. These solvents may be used alone, or two or more kinds may be used by mixing.

As a coating method in formation of the antistatic layer, the known coating method is appropriately used, and examples include roll coating, gravure coating, reverse coating, roll brushing, spray coating, and air knife coating methods, an immersing and curtain coating method, and an extrusion coating method with a die coater.

A thickness of the aforementioned antistatic resin layer, electrically conductive polymer or electrically conductive resin is usually 0.01 to 5 μm, preferably around 0.03 to 1 μm. Within the above range, the plastic film is less likely to degrade in heat resistance, solvent resistance and flexibility, which is preferred.

Examples of a method of depositing or plating an electrically conductive substance include vacuum deposition, sputtering, ion plating, chemical deposition, spray pyrolysis, chemical plating, and electric plating methods.

The conductive materials layer generally has a thickness of 2 to 1,000 nm, preferably 5 to 500 nm.

The antistatic agent described above is appropriately used as the kneading-type antistatic agent. The kneading-type antistatic agent may be used at a content of 20% by mass or less, preferably 0.05 to 10% by mass, based on the total weight of the plastic film. Any kneading methods capable of uniformly mixing the antistatic agent into the resin used to form the plastic film may be used, such as methods using a heating roll, a Banbury mixer, a pressure kneader, a biaxial kneader, or other kneading machines.

If desired, a release liner may be laminated to the surface of the pressure-sensitive adhesive layer of the pressure-sensitive adhesive sheet of an embodiment or the surface protective sheet or optical surface protective sheet described below so that the pressure-sensitive adhesive surface can be protected.

A paper sheet or a plastic film may be used to form the release liner. A plastic film is advantageously used due to its good surface smoothness. Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The release liner generally has a thickness of about 5 to about 200 μm, preferably about 10 to about 100 μm. Within the range, good workability can be achieved for laminating to and removal from the pressure-sensitive adhesive layer, which is preferred. If desired, the release liner may be subjected to a release treatment and an anti-pollution treatment with a silicone, fluoride, long-chain alkyl, or fatty acid amide release agent, a silica powder or the like, or subjected to an antistatic treatment of coating type, kneading and mixing type, vapor-deposition type, or the like.

The pressure-sensitive adhesive sheet of an embodiment has such properties that its adhesive strength at a high peeling speed is relatively low and its adhesive strength at a low peeling speed is high enough to prevent problems such as lifting and unintended separation.

The adhesive strength at a low peeling speed can be evaluated using a 180° peel test, in which the adhesive strength test is performed while the sheet is peeled off at a tensile speed of 0.3 m/minute and a peel angle of 180°, and an adhesive strength of 0.07 N/25 mm or more is evaluated as good. In this 180° peel test, the adhesive strength is more preferably 0.08 N/25 mm or more, even more preferably 0.1 N/25 mm or more. In this 180° peel test, the upper limit of the adhesive strength is generally, but not limited to, 1.0 N/25 mm or less. In this 180° peel test, the adhesive strength may be measured using the method and the specific conditions described below in the examples.

The adhesive strength at a high peeling speed can be evaluated using a 180° peel test, in which the adhesive strength test is performed while the sheet is peeled off at a tensile speed of 30 m/minute and a peel angle of 180°, and an adhesive strength of 7.0 N/25 mm or less is evaluated as good. In this 180° peel test, the adhesive strength is more preferably 6.0 N/25 mm or less, even more preferably 5.0 N/25 mm or less. In this 180° peel test, the lower limit of the adhesive strength is generally, but not limited to, 0.05 N/25 mm or more. In this 180° peel test, the adhesive strength may be measured using the method and the conditions described below in the examples.

The pressure-sensitive adhesive sheet of an embodiment also has good antistatic properties. When peeled off at a peel angle of 150° and a peeling speed of 10 m/minute, the pressure-sensitive adhesive sheet of an embodiment preferably has an absolute value of peeling electrification voltage of 1.0 kV or less, more preferably 0.5 kV or less (in an environment at 20° C. and 25% RH or at 23° C. and 50% RH). Within the range, dust stick and damage to electronic components can be advantageously prevented, which would otherwise be caused by static electricity.

The pressure-sensitive adhesive sheet of an embodiment is also characterized by having high transparency. The transparency of the removable pressure-sensitive adhesive sheet of an embodiment can be evaluated by measuring its haze. In particular, a haze of less than 10% is evaluated as good. The haze is more preferably less than 8.5%, even more preferably less than 7%. Specifically, the haze can be measured using the method and conditions described below in the examples.

The pressure-sensitive adhesive sheet of an embodiment, which has the above properties, can be used as a removable pressure-sensitive adhesive sheet or an antistatic pressure-sensitive adhesive sheet, based on its removability and antistatic properties. Also based on the properties, the pressure-sensitive adhesive sheet of an embodiment is advantageously used as a surface protective sheet, especially, a surface protective sheet (film) for protecting the surface of an optical member such as a polarizing plate, a wavelength plate, an optical compensation film, or a reflective sheet. The pressure-sensitive adhesive sheet of an embodiment may also be used in the form of a surface protective sheet-laminated optical film, which includes the optical member and the optical surface protective sheet laminated thereto.

### [Surface Protective Sheet]

As described above, the pressure-sensitive adhesive sheet of an embodiment has such properties that its adhesive strength at a high peeling speed is relatively low and its adhesive strength at a low peeling speed is high enough to prevent problems such as lifting and unintended separation. In a preferred mode, therefore, the pressure-sensitive adhesive sheet is used as a surface protective sheet for protecting the surface of a variety of adherends (objects to be protected). Examples of adherends (objects to be protected) on which the surface protective sheet of an embodiment can be used include automobiles (paint films on automobile bodies), building materials, home electric appliances, and other products produced using a variety of resins such as polyethylene (PE), polypropylene (PP), acrylonitrile-butadiene-styrene copolymer (ABS), styrene-butadiene-styrene block copolymer (SBS), polycarbonate (PC), polyvinyl chloride (PVC), and acrylic resins such as polymethyl methacrylate resin (PMMA), metals such as stainless steel (SUS) and aluminum, glass, and other materials.

When the pressure-sensitive adhesive sheet of an embodiment is used as a surface protective sheet, the removable pressure-sensitive adhesive sheet described above may be used as it is. Particularly in view of workability or the prevention of scratching or staining, a polyolefin, polyester, or polyvinyl chloride film with a thickness of 10 to 100 μm is preferably used as the support of the surface protective sheet. The pressure-sensitive adhesive layer preferably has a thickness of about 3 to about 60 μm.

### [Optical Surface Protective Sheet]

In addition to having the pressure-sensitive adhesive properties described above, the surface protective sheet of an embodiment is also characterized by having particularly high transparency. Therefore, it is preferably used as an optical surface protective sheet for protecting the surface of optical films. Examples of optical films on which the optical surface protective sheet of an embodiment can be used include polarizing plates, wavelength plates, optical compensation films, light diffusion sheets, reflective sheets, anti-reflection sheets, brightness enhancement films, transparent conductive films (ITO films), and other components for use in image display devices such as liquid crystal displays, plasma displays, and organic electroluminescent (EL) displays.

The optical surface protective sheet of an embodiment may be used in applications for protecting optical films such as polarizing plates during delivery from manufacturers, applications for protecting optical films during the process of manufacturing display devices (liquid crystal modules) in manufacturers of image display devices such as liquid crystal display devices, and applications for protecting optical films in various processes such as punching and cutting.

The removable pressure-sensitive adhesive sheet of an embodiment may be used by itself as an optical surface protective sheet. Particularly in view of transparency, workability, and the prevention of scratching or staining, a polyolefin, polyethylene terephthalate, polybutylene terephthalate, or polyethylene naphthalate film with a thickness of 10 to 100 μm is preferably used as the support of the optical film surface protective sheet. The pressure-sensitive adhesive layer preferably has a thickness of about 3 to about 40 μm.

### [Surface Protective Sheet-Laminated Optical Film]

In an embodiment, the optical surface protective sheet is preferably laminated to the optical film to form a surface protective sheet-laminated optical film. In an embodiment, such a surface protective sheet-laminated optical film include the optical film and the optical surface protective sheet or sheets laminated to one or both sides of the optical film. The surface protective sheet-laminated optical film of an embodiment can protect the optical film from scratching or deposition of dust or dirt during the delivery of the optical film from an optical film manufacturer, during the process of manufacturing display devices (liquid crystal modules) in a manufacturer of image display devices such as liquid crystal display devices, and during various processes such as punching and cutting. The surface protective sheet-laminated optical film can be inspected as it is because the optical surface protective sheet is highly transparent. If no longer needed, the optical surface protective sheet can be easily removed without any damage to the optical film or the image display device.

As described above, the pressure-sensitive adhesive composition according to an embodiment contains 100 parts by mass of the polymer (A) with a glass transition temperature of less than 0° C., 0.1 to 20 parts by mass of the polymer (B) having a weight average molecular weight of 1,000 to less than 100,000 and containing a monomer unit derived from a monomer having a nitrogen-containing structure, and 0.1 to 20 parts by mass of the acidic compound (C) with a pKa of −12.0 to less than 3.5. Therefore, the use of the pressure-sensitive adhesive composition makes it possible to form a pressure-sensitive adhesive layer having good antistatic properties, a relatively low adhesive strength at high peeling speeds, an adhesive strength high enough to prevent problems such as lifting and unintended separation at low peeling speeds, and particularly improved transparency.

Due to such excellent properties, a (removable) pressure-sensitive adhesive sheet including a support and a pressure-sensitive adhesive layer provided on the support and made from the pressure-sensitive adhesive composition of an embodiment can be used as a surface protective sheet and, in particular, is advantageously used as an optical surface protective sheet for protecting the surface of optical films. The pressure-sensitive adhesive sheet can also be used in the form of a surface protective sheet-laminated optical film, which includes an optical film and the optical surface protective sheet laminated thereto.

The removable pressure-sensitive adhesive sheet has antistatic properties, so that it can suppress the peeling electrification voltage when peeled off from a non-antistatic adherend, and also has a relatively low adhesive strength at high peeling speeds and an adhesive strength high enough to prevent problems such as lifting and unintended separation at low peeling speeds. This may be because the polymer (B) containing a monomer unit derived from a monomer having a nitrogen-containing structure can increase the ionic dissociation and ionic conductivity of the acidic compound (C) and suppress an increase in adhesive strength at high peeling speeds.

### EXAMPLES

Hereinafter, the invention will be more specifically described with reference to examples, which however are not intended to limit the invention. Table 2 shows the components of the pressure-sensitive adhesive composition and the gel fraction of the pressure-sensitive adhesive layer for each of Examples 1 to 6 and Comparative Examples 1 to 5. Table 3 shows the evaluation results. As used herein, the term “component (A)” means the polymer (A), and the term “component (B)” means the polymer (B).

<Preparation of (meth)acryl-Based Polymer (a1) (2EHA/HEA=96/4) as Component (A)>

A four-neck flask equipped with a stirring blade, a thermometer, a nitrogen gas-introducing tube, a condenser, and a dropping funnel was charged with 96 parts by mass of 2-ethylhexyl acrylate (2EHA), 4 parts by mass of 2-hydroxyethyl acrylate (HEA), 0.2 parts by mass of 2,2′-azobisisobutyronitrile as a polymerization initiator, and 150 parts by mass of ethyl acetate. Nitrogen gas was introduced into the flask while the mixture was gently stirred, and a polymerization reaction was performed for 6 hours while the temperature of the liquid in the flask was kept at about 65° C., so that a solution (40% by mass) of a (meth)acryl-based polymer (a1) was obtained. The (meth)acryl-based polymer (a1) had a glass transition temperature of −68° C., which was calculated from the Fox equation, and a weight average molecular weight of 550,000.

<Preparation of (meth)acryl-Based Polymer (a2) (2EHA/AA/HEA=85/10/5) as Component (A)>

A four-neck flask equipped with a stirring blade, a thermometer, a nitrogen gas-introducing tube, a condenser, and a dropping funnel was charged with 85 parts by mass of 2-ethylhexyl acrylate (2EHA), 10 parts by mass of acrylic acid (AA), 5 parts by mass of 2-hydroxyethyl acrylate (HEA), and 233 parts by mass of ethyl acetate. After the mixture was stirred under a nitrogen atmosphere at 60° C. for 1 hour, 0.2 parts by mass of 2,2′-azobisisobutyronitrile as a polymerization initiator was added to the mixture. The mixture was allowed to react at 60° C. for 4 hours and then at 70° C. for 3 hours, so that a solution (30% by mass) of a (meth)acryl-based polymer (a2) was obtained. The (meth)acryl-based polymer (a2) had a glass transition temperature of −58° C., which was calculated from the Fox equation, and a weight average molecular weight of 490,000.

<Preparation of (meth)acryl-Based Polymer (a3) (2EHA/NVP/HEA=85/10/5) as Component (A)>

A four-neck flask equipped with a stirring blade, a thermometer, a nitrogen gas-introducing tube, a condenser, and a dropping funnel was charged with 85 parts by mass of 2-ethylhexyl acrylate (2EHA), 10 parts by mass of N-vinylpyrrolidone (NVP), 5 parts by mass of 2-hydroxyethyl acrylate (HEA), and 233 parts by mass of ethyl acetate. After the mixture was stirred under a nitrogen atmosphere at 60° C. for 1 hour, 0.2 parts by mass of 2,2′-azobisisobutyronitrile as a polymerization initiator was added to the mixture. The mixture was allowed to react at 60° C. for 4 hours and then at 70° C. for 3 hours, so that a solution (30% by mass) of a (meth)acryl-based polymer (a3) was obtained. The (meth)acryl-based polymer (a3) had a glass transition temperature of −60° C., which was calculated from the Fox equation, and a weight average molecular weight of 1,380,000.

<Preparation of (meth)acryl-Based Polymer (b1) (NVP/2EHA=20/80) as Component (B)>

A four-neck flask equipped with a stirring blade, a thermometer, a nitrogen gas-introducing tube, a condenser, and a dropping funnel was charged with 100 parts by mass of ethyl acetate, 80 parts by mass of 2-ethylhexyl acrylate (2EHA), 20 parts by mass of N-vinylpyrrolidone (NVP), and 3 parts by mass of methyl thioglycolate as a chain transfer agent. After the mixture was stirred under a nitrogen atmosphere at 70° C. for 1 hour, 0.2 parts by mass of azobisisobutyronitrile as a thermal polymerization initiator was added to the mixture. The mixture was allowed to react at 70° C. for 2 hours and then at 80° C. for 5 hours. The resulting (meth)acryl-based polymer (b1) had a glass transition temperature of −53° C., which was calculated from the Fox equation, and a weight average molecular weight of 48,000.

<Preparation of (meth)acryl-Based Polymer (b2) (ACMO/2EHA=60/40) as Component (B)>

A four-neck flask equipped with a stirring blade, a thermometer, a nitrogen gas-introducing tube, a condenser, and a dropping funnel was charged with 100 parts by mass of ethyl acetate, 40 parts by mass of 2-ethylhexyl acrylate (2EHA), 60 parts by mass of acryloyl morpholine (ACMO), and 3 parts by mass of methyl thioglycolate as a chain transfer agent. After the mixture was stirred under a nitrogen atmosphere at 70° C. for 1 hour, 0.2 parts by mass of azobisisobutyronitrile as a thermal polymerization initiator was added to the mixture. The mixture was allowed to react at 70° C. for 2 hours and then at 80° C. for 5 hours. The resulting (meth)acryl-based polymer (b2) had a glass transition temperature of 21° C., which was calculated from the Fox equation, and a weight average molecular weight of 10,000.

### Example 1

### Preparation of Pressure-Sensitive Adhesive Composition

The (meth)acryl-based polymer (a1) solution (40% by mass) was diluted with ethyl acetate to 20% by mass. To 500 parts by mass of the resulting solution (containing 100 parts by mass of the (meth)acryl-based polymer (a1)) were added 1 part by weight of the (meth)acryl-based polymer (b1), 4 parts by mass of methanesulfonic acid (MSA manufactured by Tokyo Chemical Industry Co., Ltd., pKa: −1.9, reference: Can. J. Chem., 1978, 56, 2342-2354) as an acidic compound, and 4 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (1).

### (Preparation of Pressure-Sensitive Adhesive Sheet)

The pressure-sensitive adhesive composition (1) was applied to the surface of an antistatic layer-bearing polyethylene terephthalate film (Diafoil T100G38 (trade name) manufactured by Mitsubishi Plastics, Inc, 38 μm in thickness) opposite to its antistatically-treated surface, and then heated at 130° C. for 2 minutes to form a 15-μm-thick pressure-sensitive adhesive layer. Subsequently, the silicone-treated surface of a release liner (a 25-μm-thick polyethylene terephthalate film with its one side silicone-treated) was bonded to the surface of the pressure-sensitive adhesive layer, so that a pressure-sensitive adhesive sheet was obtained.

### Example 2

### Preparation of Pressure-Sensitive Adhesive Composition

The (meth)acryl-based polymer (a2) solution (30% by mass) was diluted with ethyl acetate to 20% by mass. To 500 parts by mass of the resulting solution (containing 100 parts by mass of the (meth)acryl-based polymer (a2)) were added 1 part by weight of the (meth)acryl-based polymer (b1), 2 parts by mass of methanesulfonic acid (MSA manufactured by Tokyo Chemical Industry Co., Ltd., pKa: −1.9, reference: Can. J. Chem., 1978, 56, 2342-2354) as an acidic compound, and 4 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (2).

### (Preparation of Pressure-Sensitive Adhesive Sheet)

A pressure-sensitive adhesive sheet was prepared as in Example 1, except that the pressure-sensitive adhesive composition (2) was used instead of the pressure-sensitive adhesive composition (1).

### Example 3

### Preparation of Pressure-Sensitive Adhesive Composition

The (meth)acryl-based polymer (a2) solution (30% by mass) was diluted with ethyl acetate to 20% by mass. To 500 parts by mass of the resulting solution (containing 100 parts by mass of the (meth)acryl-based polymer (a2)) were added 2.5 parts by mass of the (meth)acryl-based polymer (b1), 1 part by weight of methanesulfonic acid (MSA manufactured by Tokyo Chemical Industry Co., Ltd., pKa: −1.9, reference: Can. J. Chem., 1978, 56, 2342-2354) as an acidic compound, and 4 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (3).

### (Preparation of Pressure-Sensitive Adhesive Sheet)

A pressure-sensitive adhesive sheet was prepared as in Example 1, except that the pressure-sensitive adhesive composition (3) was used instead of the pressure-sensitive adhesive composition (1).

### Example 4

### Preparation of Pressure-Sensitive Adhesive Composition

The (meth)acryl-based polymer (a1) solution (40% by mass) was diluted with ethyl acetate to 20% by mass. To 500 parts by mass of the resulting solution (containing 100 parts by mass of the (meth)acryl-based polymer (a1)) were added 2.5 parts by mass of the (meth)acryl-based polymer (b1), 4 parts by mass of methanesulfonic acid (MSA manufactured by Tokyo Chemical Industry Co., Ltd., pKa: −1.9, reference: Can. J. Chem., 1978, 56, 2342-2354) as an acidic compound, 0.2 parts by mass of polyoxyalkylene-modified polydimethylsiloxane (KF6004 manufactured by Shin-Etsu Chemical Co., Ltd.), and 4 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (4).

### (Preparation of Pressure-Sensitive Adhesive Sheet)

A pressure-sensitive adhesive sheet was prepared as in Example 1, except that the pressure-sensitive adhesive composition (4) was used instead of the pressure-sensitive adhesive composition (1).

### Example 5

### Preparation of Pressure-Sensitive Adhesive Composition

The (meth)acryl-based polymer (a1) solution (40% by mass) was diluted with ethyl acetate to 20% by mass. To 500 parts by mass of the resulting solution (containing 100 parts by mass of the (meth)acryl-based polymer (a1)) were added 2.5 parts by mass of the (meth)acryl-based polymer (b1), 2.5 parts by mass of an alkyl phosphate ester compound (PHOSPHANOL BH-650 manufactured by TOHO Chemical Industry Co., Ltd., pKa: 2.5 (measured value)) as an acidic compound, and 4 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (5).

### (Preparation of Pressure-Sensitive Adhesive Sheet)

A pressure-sensitive adhesive sheet was prepared as in Example 1, except that the pressure-sensitive adhesive composition (5) was used instead of the pressure-sensitive adhesive composition (1).

### Example 6

### Preparation of Pressure-Sensitive Adhesive Composition

The (meth)acryl-based polymer (a1) solution (40% by mass) was diluted with ethyl acetate to 20% by mass. To 500 parts by mass of the resulting solution (containing 100 parts by mass of the (meth)acryl-based polymer (a1)) were added 2.5 parts by mass of the (meth)acryl-based polymer (b2), 5 parts by mass of dodecyl phosphate (manufactured by Wako Pure Chemical Industries, Ltd., pKa: 3.4 (measured value)) as an acidic compound, and 4.0 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (6).

### (Preparation of Pressure-Sensitive Adhesive Sheet)

A pressure-sensitive adhesive sheet was prepared as in Example 1, except that the pressure-sensitive adhesive composition (6) was used instead of the pressure-sensitive adhesive composition (1).

### Comparative Example 1

### Preparation of Pressure-Sensitive Adhesive Composition

The (meth)acryl-based polymer (a1) solution (40% by mass) was diluted with ethyl acetate to 20% by mass. To 500 parts by mass of the resulting solution (containing 100 parts by mass of the (meth)acryl-based polymer (a1)) were added 0.06 parts by mass of lithium bis(trifluoromethanesulfonyl)imide (LiTFSI manufactured by Tokyo Chemical Industry Co., Ltd.), 0.5 parts by mass of polyoxyalkylene-modified polydimethylsiloxane (KF6004 manufactured by Shin-Etsu Chemical Co., Ltd.), and 3.3 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (7).

### (Preparation of Pressure-Sensitive Adhesive Sheet)

A pressure-sensitive adhesive sheet was prepared as in Example 1, except that the pressure-sensitive adhesive composition (7) was used instead of the pressure-sensitive adhesive composition (1).

### Comparative Example 2

### Preparation of Pressure-Sensitive Adhesive Composition

A pressure-sensitive adhesive composition (8) was prepared as in Example 1, except that the (meth)acryl-based polymer (b1) was not used.

### (Preparation of Pressure-Sensitive Adhesive Sheet)

A pressure-sensitive adhesive sheet was prepared as in Example 1, except that the pressure-sensitive adhesive composition (8) was used instead of the pressure-sensitive adhesive composition (1).

### Comparative Example 3

### Preparation of Pressure-Sensitive Adhesive Composition

A pressure-sensitive adhesive composition (9) was prepared as in Example 1, except that 3 parts by mass of dioctyltin dilaurate (a 1% by mass ethyl acetate solution) was added as a crosslinking catalyst and that methanesulfonic acid (MSA manufactured by Tokyo Chemical Industry Co., Ltd., pKa: −1.9, reference: Can. J. Chem., 1978, 56, 2342-2354) as an acidic compound was not used.

(Preparation of Pressure-Sensitive Adhesive Sheet)

A pressure-sensitive adhesive sheet was prepared as in Example 1, except that the pressure-sensitive adhesive composition (9) was used instead of the pressure-sensitive adhesive composition (1).

### Comparative Example 4

### Preparation of Pressure-Sensitive Adhesive Composition

The (meth)acryl-based polymer (a3) solution (30% by mass) was diluted with ethyl acetate to 20% by mass. To 500 parts by mass of the resulting solution (containing 100 parts by mass of the (meth)acryl-based polymer (a3)) were added 4 parts by mass of methanesulfonic acid (MSA manufactured by Tokyo Chemical Industry Co., Ltd., pKa: −1.9, reference: Can. J. Chem., 1978, 56, 2342-2354) as an acidic compound, and 4.0 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (10).

### (Preparation of Pressure-Sensitive Adhesive Sheet)

A pressure-sensitive adhesive sheet was prepared as in Example 1, except that the pressure-sensitive adhesive composition (10) was used instead of the pressure-sensitive adhesive composition (1).

### Comparative Example 5

### Preparation of Pressure-Sensitive Adhesive Composition

The (meth)acryl-based polymer (a1) solution (40% by mass) was diluted with ethyl acetate to 20% by mass. To 500 parts by mass of the resulting solution (containing 100 parts by mass of the (meth)acryl-based polymer (a1)) were added 2.5 parts by mass of the (meth)acryl-based polymer (b1), 11.8 parts by mass of oleic acid (manufactured by Wako Pure Chemical Industries, Ltd., pKa: 9.9, reference: Journal of Colloid and Interface Science, 256, 201-207 (2002)) as an acidic compound, and 4 parts by mass of CORONATE L (an ethyl acetate solution of a trimethylolpropane-tolylene diisocyanate trimer adduct (75% by mass solid content) manufactured by Nippon Polyurethane Industry Co., Ltd.) as a crosslinking agent. The mixture was stirred at 25° C. for about 5 minutes to form a pressure-sensitive adhesive composition (11).

### (Preparation of Pressure-Sensitive Adhesive Sheet)

A pressure-sensitive adhesive sheet was prepared as in Example 1, except that the pressure-sensitive adhesive composition (11) was used instead of the pressure-sensitive adhesive composition (1).

### (Measurement Methods and Evaluation Methods)

### <Measurement of Molecular Weight>

The weight average molecular weight (Mw) of the (meth)acryl-based polymer (a1) as the component (A) was measured using a GPC system (HLC-8220GPC manufactured by TOSOH CORPORATION). The measurement conditions were as shown below, and the standard polystyrene-equivalent molecular weight was determined. Table 2 shows the measurement results.
Sample concentration: 0.2% by mass (tetrahydrofuran (THF) solution)
Sample injection volume: 10 it
Eluent: THF
Flow rate: 0.6 ml/minute
Measurement temperature: 40° C.
Columns:
Sample columns: TSK guard column Super HZ-H×1+TSK gel Super HZM-H×2
Reference column: TSK gel Super H-RC×1
Detector: differential refractometer (RI)

Based on one equivalent of acrylic acid, two equivalents of trimethylsilyldiazomethane was added to the (meth)acryl-based polymer (a2) as the component (A) and allowed to stand for a day before the THF solution was prepared.

The (meth)acryl-based polymer (a3) as the component (A) and the (meth)acryl-based polymers (b1) and (b2) as the component (B) were measured under the conditions shown below. The sample was diluted with an amine component-containing THF solution.
Sample injection volume: 100 μl
Eluent: amine component-containing THF solution
Flow rate: 0.5 ml/minute
Measurement temperature: 40° C.
Column:
Sample column: TSK gel GMH-H(S)
Detector: differential refractometer (RI)
   <Measurement of pKa>

An aqueous solution of 0.01 mol/L of the acidic compound was prepared, and then 50 mL of the aqueous solution was subjected to neutralization titration, in which a 0.1 mol/L potassium hydroxide aqueous solution was added dropwise using a titrator (COM550 manufactured by Hiranuma Sangyo Corporation, using electrode GR501). From the point of neutralization and the titration curve, the mixing amount of the alkali was read at the half-point of neutralization, and the pH at that point was used as the pKa. Table 2 shows the measurement results.

### <Measurement of Gel Fraction (Solvent-Insoluble Component Content)>

The solvent-insoluble component content (gel fraction) was determined as follows. The pressure-sensitive adhesive layer was sampled in an amount of 0.1 g. The sample was precisely weighed (the weight before immersion) and then immersed in about 50 ml of ethyl acetate at room temperature (20-25° C.) for one week. Subsequently, the solvent (ethyl acetate)-insoluble fraction was taken out and then dried at 130° C. for 2 hours. Subsequently, the dried fraction was weighed (the weigh after immersion and drying), and the gel fraction (solvent-insoluble component content) was calculated based on formula (2) below. Table 2 shows the measurement results.

Gel fraction (solvent-insoluble component content) (% by mass)=[(the weight after immersion and drying)/(the weight before immersion)]×100 (2)

TABLE 2

| | Polymer (A) | | | | | Polymer (B) | | | |
|---|---|---|---|---|---|---|---|---|---|
| | | Composition | | | mass | | Composition | | |
| | Name | (mass ratio) | Mw | Tg | parts | Name | (mass ratio) | Mw | Tg |
| Example 1 | (a1) | 2EHA/HEA = | 550,000 | −68 | 100 | (b1) | NVP/2EHA = | 48000 | −53 |
| | | 96/4 | | | | | 20/80 | | |
| Example 2 | (a2) | 2EHA/AA/HEA = | 490,000 | −58 | 100 | (b1) | NVP/2EHA = | 48000 | −53 |
| | | 85/10/5 | | | | | 20/80 | | |
| Example 3 | (a2) | 2EHA/AA/HEA = | 490,000 | −58 | 100 | (b1) | NVP/2EHA = | 48000 | −53 |
| | | 85/10/5 | | | | | 20/80 | | |
| Example 4 | (a1) | 2EHA/HEA = | 550,000 | −68 | 100 | (b1) | NVP/2EHA = | 48000 | −53 |
| | | 96/4 | | | | | 20/80 | | |
| Example 5 | (a1) | 2EHA/HEA = | 550,000 | −68 | 100 | (b1) | NVP/2EHA = | 48000 | −53 |
| | | 96/4 | | | | | 20/80 | | |
| Example 6 | (a1) | 2EHA/HEA = | 550,000 | −68 | 100 | (b2) | ACMO/2EHA = | 10000 | 21 |
| | | 96/4 | | | | | 60/40 | | |
| Comparative | (a1) | 2EHA/HEA = | 550,000 | −68 | 100 | — | — | — | — |
| Example 1 | | 96/4 | | | | | | | |
| Comparative | (a1) | 2EHA/HEA = | 550,000 | −68 | 100 | — | — | — | — |
| Example 2 | | 96/4 | | | | | | | |
| Comparative | (a1) | 2EHA/HEA = | 550,000 | −68 | 100 | (b1) | NVP/2EHA = | 48000 | −53 |
| Example 3 | | 96/4 | | | | | 20/80 | | |
| Comparative | (a3) | 2EHA/NVP/HEA = | 1,380,000 | −60 | 100 | — | — | — | — |
| Example 4 | | 85/10/5 | | | | | | | |
| Comparative | (a1) | 2EHA/HEA = | 550,000 | −68 | 100 | (b1) | NVP/2EHA = | 48000 | −53 |
| Example 5 | | 96/4 | | | | | 20/80 | | |

| | | | | | | | | | Gel |
|---|---|---|---|---|---|---|---|---|---|
| | | | | | | | | | fraction |
| | | | | | | | | | (% by |
| | | | | | | | | | mass) |
| | | | | | | | | | of |
| | Polymer | | | | | | | | pressure- |
| | (B) | Acidic compound (C) | | | Other components | | | | sensitive |
| | mass | | | mass | Alkali | mass | POA | mass | adhesive |
| | parts | Acid | pKa | parts | metal salt | parts | compound | parts | layer |
| Example 1 | 1 | MSA | −1.9 | 4 | — | — | — | — | 90.7 |
| Example 2 | 1 | MSA | −1.9 | 2 | — | — | — | — | 92.8 |
| Example 3 | 2.5 | MSA | −1.9 | 1 | — | — | — | — | 92.9 |
| Example 4 | 2.5 | MSA | −1.9 | 4 | — | — | KF | 0.2 | 88.8 |
| | | | | | | | 6004 | | |
| Example 5 | 2.5 | PHOSPHANOL | 2.5 | 2.5 | — | — | — | — | 86.6 |
| | | BH-650 | | | | | | | |
| Example 6 | 2.5 | DPA | 3.4 | 5 | — | — | — | — | 86.8 |
| Comparative | — | — | — | — | LiTFSI | 0.06 | KF | 0.5 | 94.4 |
| Example 1 | | | | | | | 6004 | | |
| Comparative | — | MSA | −1.9 | 4 | — | — | — | — | 91.3 |
| Example 2 | | | | | | | | | |
| Comparative | 2.5 | — | — | — | — | — | — | — | 94.0 |
| Example 3 | | | | | | | | | |
| Comparative | — | MSA | −1.9 | 4 | — | — | — | — | 93.5 |
| Example 4 | | | | | | | | | |
| Comparative | 2.5 | Oleic acid | 9.9 | 11.8 | — | — | — | — | 83.1 |
| Example 5 | | | | | | | | | |

Remarks: The abbreviations in Table 2 represent the following compounds. The number of mass part s indicates the solid content.
POA compound: polyoxyalkylene chain-containing compound
2EHA: 2-ethylhexyl acrylate
HEA: 2-hydroxyethyl acrylate
AA: acrylic acid
NVP: N-vinyl-2-pyrrolidone
ACMO: acryloyl morpholine
MSA: methanesulfonic acid
PHOSPHANOL BH-650: alkyl phosphate ester compound
DPA: dodecyl phosphate
LiTFSI: lithium bis(trifluoromethanesulfonyl)imide
KF6004: polyoxyalkylene-modified polydimethylsiloxane

### <Low Peeling Speed Test for Adhesive Strength at 180° Peel (Adhesive Strength at Low Peeling Speed)>

The pressure-sensitive adhesive sheet of each of the examples and the comparative examples was cut into a piece with a size of 25 mm in width and 100 mm in length, and the release liner was peeled off. Subsequently, the resulting piece was pressure-laminated onto the surface of a triacetylcellulose polarizing plate (SEG1425DU manufactured by NITTO DENKO CORPORATION, 70 mm wide, 100 mm long) using a hand roller and then subjected to lamination under the pressure-laminating conditions of 0.25 MPa and 0.3 m/minute to form an evaluation sample (a surface protective sheet-laminated optical film).

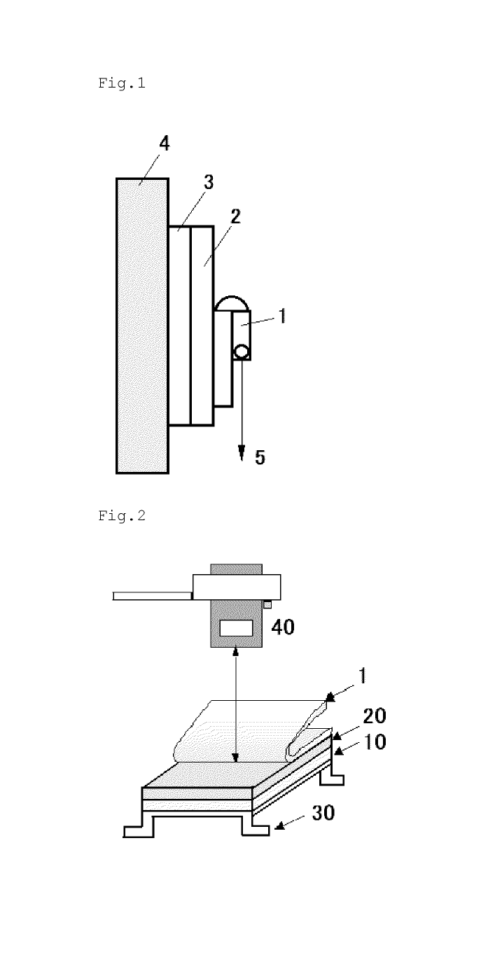

After the lamination, the sample was allowed to stand in an environment at 23° C. and 50% RH for 30 minutes, and then, as shown in FIG. 1, the opposite surface of the triacetylcellulose polarizing plate 2 was fixed onto an acrylic plate 4 with a double-sided pressure-sensitive adhesive tape 3. Using a universal tensile tester, the pressure-sensitive adhesive sheet 1 was peeled off by pulling its one end at a tensile speed of 0.3 m/minute and a peel angle of 180° when the adhesive strength was measured. The measurement was performed in an environment at 23° C. and 50% RH. At the low peeling speed, an adhesive strength of 0.07 N/25 mm or more was evaluated as good, and an adhesive strength of less than 0.07 N/25 mm was evaluated as poor. Table 3 shows the measurement results.

### <High Peeling Speed Test for Adhesive Strength at 180° Peel (Adhesive Strength at High Peeling Speed)>

The pressure-sensitive adhesive sheet of each of the examples and the comparative examples was cut into a piece with a size of 25 mm in width and 100 mm in length, and the release liner was peeled off. Subsequently, the resulting piece was pressure-laminated onto the surface of a triacetylcellulose polarizing plate (SEG1425DU manufactured by NITTO DENKO CORPORATION, 70 mm wide, 100 mm long) using a hand roller and then subjected to lamination under the pressure-laminating conditions of 0.25 MPa and 0.3 m/minute to form an evaluation sample (a surface protective sheet-laminated optical film).

After the lamination, the sample was allowed to stand in an environment at 23° C. and 50% RH for 30 minutes, and then, as shown in FIG. 1, the opposite surface of the triacetylcellulose polarizing plate 2 was fixed onto an acrylic plate 4 with a double-sided pressure-sensitive adhesive tape 3. Using a universal tensile tester, the pressure-sensitive adhesive sheet 1 was peeled off by pulling its one end at a tensile speed of 30 m/minute and a peel angle of 180° when the adhesive strength was measured. The measurement was performed in an environment at 23° C. and 50% RH. At the high peeling speed, an adhesive strength of 7.0 N/25 mm or less was evaluated as good, and an adhesive strength of more than 7.0 N/25 mm was evaluated as poor. Table 3 shows the measurement results.

### <Measurement of Peeling Electrification Voltage>

The pressure-sensitive adhesive sheet 1 was cut into a piece with a size of 70 mm in width and 130 mm in length, and the separator was peeled off. An acrylic plate 10 (ACRYLITE manufactured by Mitsubishi Rayon Co., Ltd, 1 mm thick, 70 mm wide, and 100 mm long) was subjected to static elimination in advance, and a polarizing plate 20 (SEG1425DU manufactured by NITTO DENKO CORPORATION, 70 mm wide, 100 mm long) was then bonded to the acrylic plate. Using a hand roller, the piece was then pressure-laminated to the surface of the polarizing plate in such a way that one end of the piece protruded 30 mm out of the plate.

The resulting sample was allowed to stand in an environment at 23° C. and 50% RH for a day. Subsequently, as shown in FIG. 2, the sample was set at the predetermined location of a sample mount 30. The one end protruding 30 mm was fixed to an automatic winder, and the piece was peeled off at a peel angle of 150° and a peeling speed of 10 m/minute. In this operation, the electrical potential generated on the surface of the polarizing plate was measured as the peeling electrification voltage using a potential meter (KSD-0103 manufactured by KASUGA ELECTRIC WORKS LTD.) fixed at a predetermined position. The measurement was performed in an environment at 20° C. and 25% RH or at 23° C. and 50% RH. The absolute value of the peeling electrification voltage is preferably 1.0 kV or less, more preferably 0.5 kV or less. Within the range, dust stick and damage to electronic components can be advantageously prevented, which would otherwise be caused by static electricity. Table 3 shows the measurement results.

### <Transparency Test (Initial Haze)>

The pressure-sensitive adhesive sheet of each of the examples and the comparative examples was cut into a piece with a size of 50 mm in width and 50 mm in length, and then the release liner was peeled off. The haze of the piece was measured using a haze meter (manufactured by MURAKAMI COLOR RESEARCH LABORATORY). A haze of less than 10% was evaluated as good, and a haze of 10% or more was evaluated as poor. Table 3 shows the measurement results.

<Transparency Test (Haze after Humidification)>

The pressure-sensitive adhesive sheet of each of the examples and the comparative examples was cut into a piece with a size of 50 mm in width and 50 mm in length. The piece was allowed to stand in an environment at 40° C. and 92% RH for 7 days, and then the release liner was peeled off. The haze of the piece was then measured using a haze meter (manufactured by MURAKAMI COLOR RESEARCH LABORATORY). A haze of less than 10% was evaluated as good, and a haze of 10% or more was evaluated as poor. Table 3 shows the measurement results.

TABLE 3

| | Adhesive strength | | | | | |
|---|---|---|---|---|---|---|
| | at 180° peel | | Peeling | | | |
| | [N/25 mm] | | electrification | | | |
| | 0.3 m/ | 0.3 m/min | voltage | | Haze [%] | |
| | min (low | (high | [kv] | | | After |
| | peeling | peeling | 20° C. × | 23° C. × | | humidi- |
| | speed) | speed) | 20% RH | 50% RH | Initial | fication |
| Example 1 | 0.229 | 1.25 | 0.0 | 0.0 | 3.6 | 3.4 |
| Example 2 | 0.469 | 0.43 | 0.0 | −0.2 | 2.0 | 6.4 |
| Example 3 | 0.117 | 0.20 | −0.3 | −0.1 | 2.0 | 5.4 |
| Example 4 | 0.207 | 3.40 | 0.0 | 0.0 | 2.1 | 2.2 |
| Example 5 | 0.193 | 4.10 | −0.2 | 0.0 | 8.3 | 4.8 |
| Example 6 | 0.104 | 1.25 | −0.5 | −0.2 | 5.4 | 4.8 |
| Comparative | 0.034 | 0.45 | 0.0 | 0.0 | 2.2 | 2.3 |
| Example 1 | | | | | | |
| Comparative | 0.301 | 8.40 | −0.3 | −0.2 | 2.4 | 5.6 |
| Example 2 | | | | | | |
| Comparative | 0.102 | 1.83 | −1.6 | −1.6 | 2.1 | 2.1 |
| Example 3 | | | | | | |
| Comparative | 0.104 | 1.20 | 0.0 | 0.0 | 1.9 | 29.1 |
| Example 4 | | | | | | |
| Comparative | 0.041 | 1.38 | −2.2 | −2.0 | 2.2 | 2.4 |
| Example 5 | | | | | | |

Table 3 shows that in all the examples, the adhesive strength falls within the desired range at the low and high peeling speeds, the occurrence of peeling electrification voltage is suppressed, and good transparency is provided because the polymer (B) used in all the examples contains a unit derived from a monomer having a nitrogen-containing structure.

On the other hand, in Comparative Example 1, the adhesive strength at the low peeling speed was not enough because neither the polymer (B) containing a unit derived from a monomer having a nitrogen-containing structure nor the acidic compound (C) was used (added). In Comparative Example 2, the adhesive strength at the high peeling speed was excessively high because the polymer (B) containing a unit derived from a monomer having a nitrogen-containing structure was not used. In comparative Example 3, the occurrence of peeling electrification voltage was not sufficiently suppressed because the acidic compound (C) was not used. In Comparative Example 4, reliable transparency was not achieved because the polymer (B) containing a unit derived from a monomer having a nitrogen-containing structure was not used whereas a monomer having a nitrogen-containing structure was used to form the polymer (A). In Comparative Example 5, the adhesive strength at the low peeling speed was not enough, and the occurrence of peeling electrification voltage was not sufficiently suppressed, because the acidic compound (C) used had a pKa value exceeding the desired range.

### DESCRIPTION OF REFERENCE SIGNS

1 Pressure-sensitive adhesive sheet
2 Polarizing plate
3 Double-sided pressure-sensitive adhesive tape
4 Acrylic plate
5 Constant load
10 Acrylic plate
20 Polarizing plate
30 Sample mount
40 Potential meter

1. A pressure-sensitive adhesive composition, comprising:
100 parts by mass of a polymer (A) with a glass transition temperature of less than 0° C.;
0.1 to 20 parts by mass of a polymer (B) having a weight average molecular weight of 1,000 or more to less than 100,000 and containing a monomer unit derived from a monomer having a nitrogen-containing structure; and
0.1 to 20 parts by mass of an acidic compound (C) with a pKa of −12.0 or more to less than 3.5.

2. The pressure-sensitive adhesive composition according to claim 1, wherein the polymer (A) is a (meth)acryl-based polymer.

3. The pressure-sensitive adhesive composition according to claim 1, wherein the polymer (B) is a (meth)acryl-based polymer.

4. The pressure-sensitive adhesive composition according to claim 1, wherein the nitrogen-containing structure is an amide bond and/or a nitrogen-containing heterocyclic ring.

5. The pressure-sensitive adhesive composition according to claim 1, wherein the acidic compound (C) is a compound having a phosphate group and/or a sulfonyl group.

6. A pressure-sensitive adhesive layer, comprising a product made from the pressure-sensitive adhesive composition according to claim 1.

7. The pressure-sensitive adhesive layer according to claim 6, which has a gel fraction of 85.00 to 99.95% by mass.

8. A pressure-sensitive adhesive sheet, comprising:
a support; and
the pressure-sensitive adhesive layer according to claim 6 formed on at least one side of the support.

9. The pressure-sensitive adhesive sheet according to claim 8, wherein the support is an antistatically treated plastic film.

10. A surface protective sheet comprising the pressure-sensitive adhesive sheet according to claim 8.

11. An optical surface protective sheet, comprising the surface protective sheet according to claim 10 for use in protecting a surface of an optical film.

12. A surface protective sheet-laminated optical film, comprising:
an optical film; and
the optical surface protective sheet according to claim 11 laminated to the optical film.
